(19) United States
(12) Patent Application Publication
(10) Pub. No.: US 2026/0133446 A1
(43) Pub. Date: May 14, 2026

(54) VIEWING ANGLE CONTROL SYSTEM AND IMAGE DISPLAY DEVICE

(71) Applicant: FUJIFILM Corporation, Tokyo (JP)

(72) Inventors: Fumitake MITOBE, Minamiashigara-shi (JP); Naoki KOITO, Minamiashigara-shi (JP)

(73) Assignee: FUJIFILM Corporation, Tokyo (JP)

(21) Appl. No.: 19/445,688

(22) Filed: Jan. 12, 2026

Related U.S. Application Data
(63) Continuation of application No. PCT/JP2024/024390, filed on Jul. 5, 2024.

(30) Foreign Application Priority Data
Jul. 24, 2023 (JP) 2023-119638
Jan. 12, 2024 (JP) 2024-003212

(51) Int. Cl. G02F 1/13; G02F 1/1335

(52) U.S. Cl. CPC G02F 1/1323; G02F 1/133528

(57) ABSTRACT

A viewing angle control system is provided that selectively switches between a light-shielding mode and a transmission mode when an image is viewed from an oblique direction at a predetermined azimuth angle, such that image visibility is reduced in the light-shielding mode and enhanced in the transmission mode. The viewing angle control system includes, in order, a light-absorbing anisotropic layer, a liquid crystal cell, and a polarizer. An angle formed between a transmittance central axis of the light-absorbing anisotropic layer and a normal line of the light-absorbing anisotropic layer is 0° to 45°. An optical compensation layer is provided between the light-absorbing anisotropic layer and the liquid crystal cell and/or between the liquid crystal cell and the polarizer. The system excludes any additional light-absorbing anisotropic layers or polarizers between the light-absorbing anisotropic layer and the polarizer.

### CROSS-REFERENCE TO RELATED APPLICATIONS

This application is a Continuation of PCT International Application No. PCT/JP2024/024390 filed on Jul. 5, 2024, which claims priority under 35 U.S.C. § 119(a) to Japanese Patent Application No. 2023-119638 filed on Jul. 24, 2023, and Japanese Patent Application No. 2024-003212 filed on Jan. 12, 2024. The above applications are hereby expressly incorporated by reference, in their entirety, into the present application.

### BACKGROUND OF THE INVENTION

### 1. Field of the Invention

The present invention relates to a viewing angle control system. In addition, the present invention also relates to an image display device including the viewing angle control system.

### 2. Description of the Related Art

In recent years, a display device such as a liquid crystal display device has been widely used as a display of a personal computer, a smartphone, or the like. In addition, the display is often employed in a mobile device. A device having such a display is often used in a public place, and a technique for preventing unauthorized viewing from others has been required.

In addition, in recent years, the liquid crystal display device is used as an in-vehicle display in a vehicle. With an increase in size of the in-vehicle display, images displayed on the display may be reflected on a windshield or the like, which may hinder a field of view of a driver, and thus a technique for preventing the reflected glare has been required.

In addition, in the above-described display, it is also preferable that a width of a viewing angle can be switched as necessary.

For example, US2021/0349335A discloses a viewing angle control system in which a width of a viewing angle can be switched, the viewing angle control system including a substrate in which a coloring agent is vertically aligned and a switching cell.

### SUMMARY OF THE INVENTION

In the viewing angle control system, it is required that, in a case where the viewing angle control system is applied to an image display device and an image is observed from an oblique direction at a specific azimuth angle, a transmission mode in which the image is visible and a light shielding mode in which the image is difficult to be visible are switched. In recent years, it is required that the image is more easily visible in the transmission mode and the image is more difficult to be visible in the light shielding mode.

As a result of studying the transmission mode and the light shielding mode described above, the present inventors have found that the technology disclosed in US2021/0349335A does not satisfy the level required in recent years and further improvement is required.

Therefore, an object of the present invention is to provide a viewing angle control system which is applied to an image display device, in which, in a case where an image is viewed from an oblique direction at a predetermined azimuth angle, a light shielding mode and a transmission mode can be switched, and the image is more difficult to be visible in the light shielding mode and the image is more easily visible in the transmission mode.

Another object of the present invention is to provide an image display device using the above-described viewing angle control system.

The present inventors have completed the present invention as a result of intensive studies to solve the above-described problems. That is, the present inventors have found that the above-described objects can be achieved by the following configuration.

[1] A viewing angle control system comprising, in the following order:
a light-absorbing anisotropic layer;
a liquid crystal cell; and
a polarizer,
in which an angle formed by a transmittance central axis of the light-absorbing anisotropic layer and a normal line of the light-absorbing anisotropic layer is 0° to 45°,
an optical compensation layer is provided in at least one of a space between the light-absorbing anisotropic layer and the liquid crystal cell or a space between the liquid crystal cell and the polarizer, and
the viewing angle control system does not include another light-absorbing anisotropic layer and another polarizer between the light-absorbing anisotropic layer and the polarizer.

[2] The viewing angle control system according to [1], in which the liquid crystal cell is an in-plane-switching type liquid crystal cell.

[3] The viewing angle control system according to [1],
in which the liquid crystal cell is a vertical alignment type liquid crystal cell or an electrically controlled birefringence type liquid crystal cell.

[4] The viewing angle control system according to any one of [1] to [3],
in which the optical compensation layer is disposed between the light-absorbing anisotropic layer and the liquid crystal cell.

[5] An image display device comprising:
the viewing angle control system according to any one of [1] to [4].

According to the present invention, it is possible to provide a viewing angle control system which is applied to an image display device, in which, in a case where an image is viewed from an oblique direction at a predetermined azimuth angle, a light shielding mode and a transmission mode can be switched, and the image is more difficult to be visible in the light shielding mode and the image is more easily visible in the transmission mode.

In addition, according to the present invention, it is possible to provide an image display device using the above-described viewing angle control system.

### BRIEF DESCRIPTION OF THE DRAWINGS

FIG. 1 is a schematic cross-sectional view showing an aspect of an image display device according to an embodiment of the present invention.

FIG. 2 is a schematic cross-sectional view for describing a principle in the aspect of the image display device according to the embodiment of the present invention.

FIG. 3 is a schematic cross-sectional view showing another aspect of the image display device according to the embodiment of the present invention.

### DESCRIPTION OF THE PREFERRED EMBODIMENTS

Hereinafter, the present invention will be described in detail.

The description of the configuration requirements described below is made on the basis of representative embodiments of the present invention, but it should not be construed that the present invention is limited to those embodiments.

Hereinafter, meaning of each description in the present specification will be explained.

In the present specification, a numerical range represented by “to” means a range including numerical values before and after “to” as a lower limit value and an upper limit value.

In the present specification, the term parallel or orthogonal does not indicate parallel or orthogonal in a strict sense, but indicates a range of ±5° from parallel or orthogonal. In addition, in the present specification, a polar angle denotes an angle with respect to a normal direction of a film.

In addition, in the present specification, a liquid crystal composition and a liquid crystal compound include those which no longer exhibit liquid crystal properties due to curing or the like as a concept.

In addition, in this specification, for each component, one kind of substance corresponding to each component may be used alone, or two or more kinds thereof may be used in combination. Here, in a case where two or more kinds of substances are used in combination for each component, the content of the component indicates the total content of the substances used in combination, unless otherwise specified.

In addition, in the present specification, “(meth)acrylate” denotes “acrylate” or “methacrylate”, “(meth)acryl” denotes “acryl” or “methacryl”, and “(meth)acryloyl” denotes “acryloyl” or “methacryloyl”.

In the present invention, refractive indices nx and ny are refractive indices in the in-plane direction of an optical member, and typically, nx represents a refractive index of a slow axis azimuth and ny represents a refractive index of a fast axis azimuth (that is, the azimuth orthogonal to the slow axis). In addition, nz represents a refractive index in a thickness direction. nx, ny, and nz can be measured, for example, with an Abbe refractometer (NAR-4T, manufactured by Atago Co., Ltd.) using a sodium lamp (λ=589 nm) as a light source. In addition, in a case of measuring wavelength dependence, it can be measured with a multi-wavelength Abbe refractometer DR-M2 (manufactured by Atago Co., Ltd.) in combination with a dichroic filter. In addition, values from Polymer Handbook (John Wiley & Sons, Inc.) and catalogs of various optical films can also be used.

In the present specification, Re(λ) and Rth(λ) respectively represent an in-plane retardation at a wavelength λ and a thickness direction retardation at a wavelength λ, and refractive indices nx, ny, and nz are represented by Equation (1) and Equation (2) using a film thickness d (μm).

$$Re ( λ ) = ( n x - n y ) \times d \times 1000 ( nm ) \qquad Equation ( 1 )$$

$$Rth ( λ ) = ( ( nx + ny ) / 2 - nz ) \times d \times 1000 ( nm ) \qquad Equation ( 2 )$$

The wavelength λ is set to 550 nm unless otherwise specified.

The slow axis azimuth, Re (λ), and Rth (λ) can be measured using, for example, AxoScan OPMF-1 (manufactured by Opto Science Inc.).

In a case of simply using Re and Rth, values at λ=550 nm are shown.

In the present specification, And is a phase difference generated by a layer in which a rod-like liquid crystal compound or a disk-like liquid crystal compound is twisted and aligned in a thickness direction as an axis, and is represented by a product of a thickness d of a liquid crystal layer and a birefringence index Δn of a liquid crystal. In addition, a twisted angle of the liquid crystal compound from one surface to the other surface of the layer in which the liquid crystal compound is twisted and aligned is also referred to as a twist angle of the liquid crystal compound.

In addition, unless otherwise specified, Δn is a value at a wavelength of 550 nm.

### <Viewing Angle Control System>

The viewing angle control system according to the embodiment of the present invention includes a light-absorbing anisotropic layer, a liquid crystal cell, and a polarizer in this order. Here, an angle formed by a transmittance central axis of the light-absorbing anisotropic layer and a normal line of the light-absorbing anisotropic layer is 0° to 45°.

In addition, an optical compensation layer is provided in at least one of a space between the light-absorbing anisotropic layer and the liquid crystal cell or a space between the liquid crystal cell and the polarizer, and the viewing angle control system does not include another light-absorbing anisotropic layer and another polarizer between the light-absorbing anisotropic layer and the polarizer.

The viewing angle control system according to the embodiment of the present invention is used as a member of an image display device to constitute the image display device according to the embodiment of the present invention.

FIG. 1 is a schematic cross-sectional view showing one aspect of an image display device using the viewing angle control system according to the embodiment of the present invention.

An image display device 100a shown in FIG. 1 includes a viewing angle control system 10a and a display panel 20. In the image display device 100a, a side of the viewing angle control system 10a opposite to the display panel 20 side is a visible side.

The viewing angle control system 10a includes a light-absorbing anisotropic layer 12, a liquid crystal cell 14, an optical compensation layer 18, and a polarizer 16 in this order from a side opposite to the display panel 20 side (visible side). An angle formed by a transmittance central axis of the light-absorbing anisotropic layer 12 and a normal line of the light-absorbing anisotropic layer 12 is 0° to 45°. In addition, the liquid crystal cell 14 shown in FIG. 1 is an in-plane-switching (IPS) type liquid crystal cell in which an alignment direction of a liquid crystal compound can be controlled in an in-plane direction.

In the image display device 100a, the alignment direction of the liquid crystal compound in the liquid crystal cell 14 is controlled, so that the light shielding mode and the transmission mode can be switched in a case where the image is viewed from an oblique direction at a predetermined azimuth angle.

In the image display device 100a shown in FIG. 1, the light shielding mode and the transmission mode can be switched.

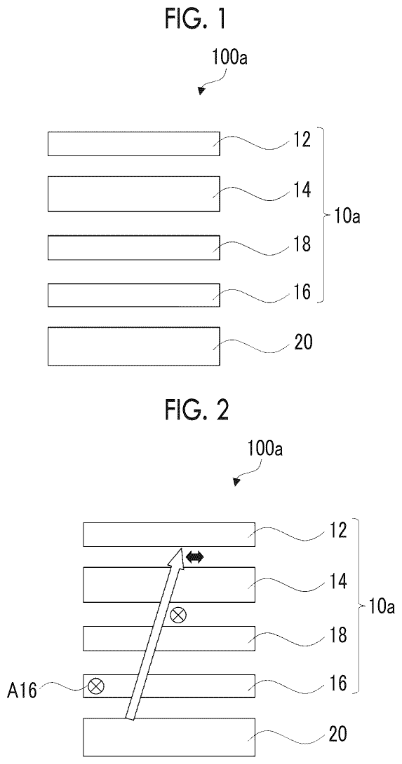

FIG. 2 is a schematic cross-sectional view of the image display device 100a for describing that the light shielding mode and the transmission mode can be switched.

A white arrow shown in FIG. 2 indicates panel light which is emitted from the display panel 20 and is emitted in an oblique direction at a predetermined azimuth angle. The configuration of the image display device 100a is the same as that shown in FIG. 1. However, in FIG. 2, a transmission axis direction A16 of the polarizer 16 is a front-back direction of the paper plane. In addition, an angle formed by a transmittance central axis of the light-absorbing anisotropic layer 12 and a normal line of the light-absorbing anisotropic layer 12 is 0°.

In a case where the above-described panel light transmits through the polarizer 16, only light having a polarization direction in the front-back direction of the paper plane is transmitted and is incident on the optical compensation layer 18. The panel light incident on the optical compensation layer 18 receives optical conversion for compensating for a phase difference described below, but is emitted from the optical compensation layer 18 while maintaining a substantially front-back polarization direction and is incident on the liquid crystal cell 14. In the liquid crystal cell 14, an alignment direction (in-plane slow axis direction) of the liquid crystal compound is controlled to be at a predetermined angle (for example, 45°) with the polarization direction of the panel light incident on the liquid crystal cell 14, and the panel light is converted into light having a polarization direction in a left-right direction of the paper plane and is emitted from the liquid crystal cell 14 by the liquid crystal compound contained in the liquid crystal cell 14.

Here, as described above, the angle formed by the transmittance central axis of the light-absorbing anisotropic layer 12 and the normal line of the light-absorbing anisotropic layer 12 is 0°. That is, for light emitted in an oblique direction, the light-absorbing anisotropic layer 12 hardly absorbs light having a polarization direction in the front-back direction of the paper plane, but easily absorbs light having a polarization direction in the left-right direction of the paper plane.

In this case, the panel light having a polarization direction in the left-right direction of the paper plane, which is incident on the light-absorbing anisotropic layer 12, is absorbed by the light-absorbing anisotropic layer 12 and is difficult to be emitted to the visible side.

That is, the above-described mode is the light shielding mode.

On the other hand, in FIG. 2, the alignment direction of the liquid crystal compound contained in the liquid crystal cell 14 is controlled not to change the polarization direction of the panel light incident on the liquid crystal cell 14, so that the polarization direction of the panel light is maintained in the front-back direction of the paper plane. For example, the alignment direction (in-plane slow axis direction) of the liquid crystal compound is controlled to be at a predetermined angle (for example, 0°) with the polarization direction of the panel light incident on the liquid crystal cell 14. In this case, since the light having a polarization direction in the front-back direction of the paper plane is hardly absorbed by the light-absorbing anisotropic layer 12, the panel light is emitted to the visible side.

That is, the above-described mode is the visible mode.

Therefore, as described above, the light shielding mode and the transmission mode can be switched by controlling the alignment direction of the liquid crystal compound contained in the liquid crystal cell 14.

In addition, even in a case where the angle formed by the transmittance central axis of the light-absorbing anisotropic layer 12 and the normal line of the light-absorbing anisotropic layer 12 is not 0°, the light shielding mode and the transmission mode can be switched by controlling the alignment direction of the liquid crystal compound contained in the liquid crystal cell 14 according to the above-described principle. A direction in which the transmittance central axis of the light-absorbing anisotropic layer 12 is projected to a surface of the light-absorbing anisotropic layer 12 from the normal direction of the light-absorbing anisotropic layer 12 is the left-right direction of the paper plane. That is, in a case where the angle formed by the transmittance central axis of the light-absorbing anisotropic layer 12 and the normal line of the light-absorbing anisotropic layer 12 is not 0°, the direction in which the transmittance central axis of the light-absorbing anisotropic layer 12 is projected to the surface of the light-absorbing anisotropic layer 12 from the normal direction of the light-absorbing anisotropic layer 12 is orthogonal to the transmission axis direction A16 of the polarizer 16.

In this case, an angle formed by an emission direction of the panel light emitted in the oblique direction at the predetermined azimuth angle in FIG. 2 and the direction of the transmittance central axis of the light-absorbing anisotropic layer 12 is a predetermined angle which is not 0°.

The panel light emitted from the display panel 20 is easily transmitted in the direction of the transmittance central axis of the light-absorbing anisotropic layer 12, and thus the image displayed on the display panel 20 is easily visible.

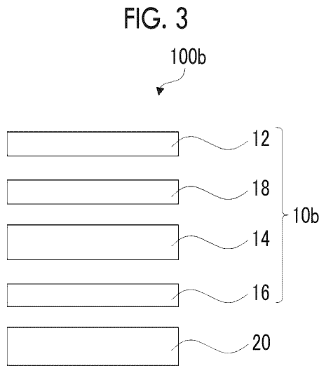

In FIGS. 1 and 2, an aspect in which the viewing angle control system 10a includes the light-absorbing anisotropic layer 12, the liquid crystal cell 14, the optical compensation layer 18, and the polarizer 16 in this order from a side opposite to the display panel 20 side (visible side) has been described. On the other hand, the viewing angle control system according to the embodiment of the present invention is not limited to the above-described aspect, and the optically compensation layer 18 may be disposed between the light-absorbing anisotropic layer 12 and the liquid crystal cell 14. The image display device having the above-described aspect will be described with reference to FIG. 3.

FIG. 3 is a schematic cross-sectional view showing one aspect of an image display device using the viewing angle control system according to the embodiment of the present invention. An image display device 100b shown in FIG. 3 includes a viewing angle control system 10b and a display panel 20. In the image display device 100b, a side of the viewing angle control system 10b opposite to the display panel 20 side is a visible side.

The viewing angle control system 10b includes a light-absorbing anisotropic layer 12, an optical compensation layer 18, a liquid crystal cell 14, and a polarizer 16 in this order from a side opposite to the display panel 20 side (visible side). An angle formed by the light-absorbing anisotropic layer 12 and a normal line of the light-absorbing anisotropic layer 12 is 0° to 45°.

Even in the above-described aspect, the light shielding mode and the transmission mode can be switched by controlling the alignment direction of the liquid crystal compound contained in the liquid crystal cell 14, according to the same principle as that described in FIGS. 1 and 2.

In the aspects of FIGS. 1 to 3, even in a case where the disposition direction of the transmission axis of the polarizer 16 is different from the above-described aspects, it is easily understood that the light shielding mode and the transmission mode described above can be switched by controlling the alignment direction of the liquid crystal compound in the liquid crystal cell 14. That is, in a case where the alignment direction of the liquid crystal compound in the liquid crystal cell 14 is adjusted, light having a desired polarization direction can be emitted, and the polarization direction can be switched, so that the light shielding mode and the transmission mode can be switched.

The light shielding mode and the transmission mode described above can be switched by controlling the alignment direction of the liquid crystal compound contained in the liquid crystal cell 14. That is, in a case where the image is viewed from an oblique direction at a predetermined azimuth angle, the light shielding mode and the transmission mode can be switched.

Here, in the image display device to which the viewing angle control system according to the embodiment of the present invention is applied, the image is more difficult to be visible in the light shielding mode, and the image is more easily visible in the transmission mode. A reason for this is not necessarily clear in detail, but is presumed to be as follows by the present inventors.

In a case of being viewed from an oblique direction at a predetermined azimuth angle, as described above, the panel light emitted in the oblique direction is handled. Since the optical member such as the liquid crystal cell has a finite thickness, the optical member may have a phase difference in the thickness direction as well as the in-plane direction. In a case where light is incident in the oblique direction, the light is affected by the phase difference in the thickness direction as well as the phase difference in the in-plane direction, and undergoes polarization conversion different from that the light is incident from the front direction. Here, in the viewing angle control system according to the embodiment of the present invention, since the optical compensation layer is provided in at least one of a space between the light-absorbing anisotropic layer and the liquid crystal cell or a space between the liquid crystal cell and the polarizer, for example, the above-described phase differences can be compensated, and the polarization state can be brought close to a polarization state in which the light is easily absorbed by the light-absorbing anisotropic layer or a polarization state in which the light is difficult to be absorbed by the light-absorbing anisotropic layer. In this case, it is considered that the image is more difficult to be visible in the light shielding mode, and the image is more easily visible in the transmission mode.

A method of switching the alignment direction of the liquid crystal compound is not limited to the above-described aspects, and a known method can be adopted. In the above-described aspects, the aspect of the IPS type liquid crystal cell has been described as the liquid crystal cell 14, but a liquid crystal cell of a type described later may be used.

In addition, in the aspects shown in FIGS. 1 to 3, the aspect in which the optical compensation layer is disposed in one of the space between the light-absorbing anisotropic layer and the liquid crystal cell or the space between the liquid crystal cell and the polarizer has been described, but the optical compensation layer may be disposed in both of the spaces.

The viewing angle control system according to the embodiment of the present invention does not include another light-absorbing anisotropic layer and another polarizer between the light-absorbing anisotropic layer and the polarizer. For example, in the aspect shown in FIG. 1, it means that, for the viewing angle control system 10a, the liquid crystal cell 14 does not include another polarizer, and the space between the polarizer 16 and the liquid crystal cell 14 and the space between the light-absorbing anisotropic layer 12 and the liquid crystal cell 14 do not include another polarizer. In addition, the space between the liquid crystal cell 14 and the polarizer 16 does not include another light-absorbing anisotropic layer.

At least one of another polarizer or another light-absorbing anisotropic layer may be disposed between the polarizer 16 and the display panel 20.

Hereinafter, configurations included in the viewing angle control system according to the embodiment of the present invention will be described.

In the aspects shown in FIGS. 1 to 3 and the above-described aspects, each configuration included in the viewing angle control system can be changed as an example of each configuration shown below, and the changed configurations can also be combined.

In addition, hereinafter, the image being more difficult to be visible in the light shielding mode is also referred to as “excellent in light shielding properties”; and the image being more easily visible in the transmission mode is also referred to as “excellent in transmittance properties”.

### [Light-Absorbing Anisotropic Layer]

In the light-absorbing anisotropic layer included in the viewing angle control system according to the embodiment of the present invention, the angle formed by the transmittance central axis of the light-absorbing anisotropic layer and the normal line of the light-absorbing anisotropic layer is 0° to 45°.

It is preferable that the light-absorbing anisotropic layer contains a dichroic substance. In a case where the light-absorbing anisotropic layer contains a dichroic substance, the above-described transmittance central axis usually matches an alignment direction of the dichroic substance.

The above-described angle can be adjusted according to a direction in which the image is to be viewed. For example, in a case where a function of preventing unauthorized viewing is imparted to the image display device, it is preferable to maximize a transmittance in the front direction. In this case, the above-described angle is preferably 0° to 10°.

In addition, the transmittance central axis of the light-absorbing anisotropic layer may be set to different directions depending on a location of the light-absorbing anisotropic layer in a plane. For example, in an in-vehicle display in which a display surface is a curved surface, in order to prevent emitted light from any position from being reflected from the windshield or the like and to allow the driver to appropriately recognize the display image, it is preferable to adjust the direction of the transmittance central axis of the light-absorbing anisotropic layer to match the curved surface.

The above-described transmittance central axis denotes a direction in which the transmittance is highest in a case where a transmittance is measured by changing an inclination angle (polar angle) and an inclination direction (azimuthal angle) with respect to the normal direction of the surface of the light-absorbing anisotropic layer. In a case of measuring the above-described angle, first, a direction of an azimuthal angle in which the transmittance central axis is inclined is detected using AxoScan OPMF-2 (manufactured by Axometrics, Inc.), the transmittance is derived by measuring Mueller matrix while various polar angles are changed in the direction of the azimuthal angle, and a direction (polar angle) having the highest transmittance is defined as the direction of the transmittance central axis of the light-absorbing anisotropic layer. The direction of the polar angle is the angle between the transmittance central axis of the light-absorbing anisotropic layer and the normal direction of the light-absorbing anisotropic layer.

The transmittance central axis (polar angle) of the light-absorbing anisotropic layer is measured at 15 sites optionally selected in the light-absorbing anisotropic layer, and an average value of the polar angles is defined as the transmittance central axis of the light-absorbing anisotropic layer.

In addition, in the present invention, the optical measurement is performed using light having a wavelength of 550 nm, unless otherwise specified.

A transmittance of light in the direction parallel to the transmittance central axis of the light-absorbing anisotropic layer is preferably 50% or more, and more preferably 70% or more. The upper limit of the transmittance is not particularly limited, but is, for example, 95% or less and is often 90% or less.

A transmittance in a direction inclined by 30° from the transmittance central axis of the light-absorbing anisotropic layer is preferably 30% or less, and more preferably 15% or less. The lower limit of the transmittance is not particularly limited, but is, for example, 0.5% or more and is often 5% or more.

The light-absorbing anisotropic layer in the present invention is preferably a layer containing at least one dichroic substance (for example, dichroic coloring agent).

The dichroic substance is not particularly limited as long as it is a substance exhibiting dichroism; and examples thereof include a dichroic coloring agent, a dichroic azo coloring agent compound, an ultraviolet absorbing substance, an infrared absorbing substance, a non-linear optical substance, a carbon nanotube, an anisotropic metal nanoparticle, and an inorganic substance.

The light-absorbing anisotropic layer can also contain two or more kinds of the dichroic substances. For example, it is preferable that the light-absorbing anisotropic layer contains a cyan coloring agent exhibiting dichroism in a wavelength range of a red color, a magenta coloring agent exhibiting dichroism in a wavelength range of a green color, and a yellow coloring agent exhibiting dichroism in a wavelength range of a blue color. In a case where the light-absorbing anisotropic layer contains a plurality of kinds of dichroic substances, the tint can be made neutral and the viewing angle control effect can be exhibited over the entire wavelength range of visible light.

The dichroic substance is a substance exhibiting dichroism, and the dichroism denotes a property in which an absorbance varies depending on the polarization direction.

An alignment degree of the dichroic substance at a wavelength of 550 nm is preferably 0.95 or more. In a case where the alignment degree of the dichroic substance is 0.95 or more, the transmittance in the direction of the absorption axis (that is, the direction in which light is expected to be transmitted) can be increased. In addition, from the viewpoint that the tint can be made neutral, an alignment degree of the dichroic substance at a wavelength of 420 nm is preferably 0.93 or more.

A thickness of the light-absorbing anisotropic layer is not particularly limited, but from the viewpoint of flexibility, it is preferably 100 to 8,000 nm and more preferably 300 to 5,000 nm.

Hereinafter, a dichroic coloring agent will be described as an example of the dichroic substance.

### (Dichroic Coloring Agent)

As the dichroic substance, a dichroic coloring agent is preferable, and a dichroic azo coloring agent compound is more preferable.

In the present invention, the dichroic azo coloring agent compound refers to an azo coloring agent compound in which an absorbance varies depending on directions.

The dichroic azo coloring agent compound may or may not exhibit liquid crystallinity.

In a case where the dichroic azo coloring agent compound exhibits liquid crystallinity, a nematic liquid crystal phase or a smectic liquid crystal phase may be exhibited. A temperature range at which the liquid crystal phase is exhibited is preferably room temperature (approximately 20° C. to 28° C.) to 300° C., and from the viewpoint of handleability and manufacturing suitability, it is more preferably 50° C. to 200° C.

In the present invention, from the viewpoint of further improving pressure resistance, it is preferable that, in a composition for forming a light-absorbing anisotropic layer described later, which is used in forming the light-absorbing anisotropic layer, the dichroic azo coloring agent compound has a crosslinkable group.

Specific examples of the crosslinkable group include a (meth)acryloyl group, an epoxy group, an oxetanyl group, and a styryl group; and among these, a (meth)acryloyl group is preferable.

Preferred examples of the dichroic azo coloring agent compound used in the present invention include a first dichroic azo coloring agent compound, a second dichroic azo coloring agent compound, and a third dichroic azo coloring agent compound.

The first dichroic azo coloring agent compound is a dichroic azo coloring agent compound having a maximum absorption wavelength in a wavelength range of 560 nm or more and 700 nm or less. In addition, the second dichroic azo coloring agent compound is a dichroic azo coloring agent compound having a maximum absorption wavelength in a wavelength range of 455 nm or more and less than 560 nm. The third dichroic azo coloring agent compound is a dichroic azo coloring agent compound having a maximum absorption wavelength in a wavelength range of 380 nm or more and 455 nm or less.

Specific examples of the first dichroic azo coloring agent compound, the second dichroic azo coloring agent compound, and the third dichroic azo coloring agent compound include compounds described in paragraphs [0161] to [0171] of WO2022/138548A, compounds described in paragraphs [0172] to [0180] of WO2022/138548A, and compounds described in paragraphs [0183] to [0206] of WO2022/138548A.

A content of the dichroic substance is preferably 1% to 30% by mass, more preferably 5% to 25% by mass, and still more preferably 10% to 20% by mass with respect to the total solid content mass of the light-absorbing anisotropic layer.

### (Liquid Crystal Compound)

It is also preferable that the light-absorbing anisotropic layer is formed of a liquid crystal composition containing the dichroic substance and a liquid crystal compound. Therefore, it is preferable that the light-absorbing anisotropic layer contains a component derived from the liquid crystal compound.

In a case where the light-absorbing anisotropic layer is formed of the above-described liquid crystal composition, the dichroic substance can be aligned at a high alignment degree while suppressing precipitation of the dichroic substance.

As the liquid crystal compound, a low-molecular-weight liquid crystal compound or a high-molecular-weight liquid crystal compound can also be used, and it is preferable that both are used in combination. Here, the “low-molecular-weight liquid crystal compound” refers to a liquid crystal compound having no repeating unit in the chemical structure. In addition, the “high-molecular-weight liquid crystal compound” refers to a liquid crystal compound having a repeating unit in the chemical structure.

The low-molecular-weight liquid crystal compound may be a compound exhibiting a nematic liquid crystal phase or a compound exhibiting a smectic liquid crystal phase; but from the viewpoint of increasing the alignment degree, a compound exhibiting a smectic liquid crystal phase is preferable. Examples thereof include liquid crystal compounds described in JP2013-228706A.

Examples of the high-molecular-weight liquid crystal compound include thermotropic liquid crystalline polymers described in JP2011-237513A. In addition, from the viewpoint of enhancing a strength (particularly, bending resistance of the film), it is preferable that the high-molecular-weight liquid crystal compound has a repeating unit having a crosslinkable group at the terminal. Examples of the crosslinkable group include polymerizable groups described in paragraphs [0040] to [0050] of JP2010-244038A. Among these, from the viewpoint of improving reactivity and synthetic suitability, an acryloyl group, a methacryloyl group, an epoxy group, an oxetanyl group, or a styryl group is preferable, and an acryloyl group or a methacryloyl group is more preferable.

In a case where the light-absorbing anisotropic layer contains the high-molecular-weight liquid crystal compound, it is preferable that the high-molecular-weight liquid crystal compound forms a nematic liquid crystal phase. A temperature range at which the nematic liquid crystal phase is exhibited is preferably room temperature (23° C.) to 450° C., and more preferably 50° C. to 400° C. from the viewpoint of handleability and manufacturing suitability.

A content of the component derived from the liquid crystal compound in the light-absorbing anisotropic layer is preferably 25 to 2,000 parts by mass, more preferably 100 to 1,300 parts by mass, and still more preferably 200 to 900 parts by mass with respect to 100 parts by mass of the content of the dichroic substance. In a case where the content of the liquid crystal compound is within the above-described range, the alignment degree of the dichroic substance is further improved.

The liquid crystal compound may be contained only one kind or two or more kinds. In a case of containing two or more kinds of the liquid crystal compounds, the above-described content of the component derived from the liquid crystal compound means the total content of the liquid crystal compounds.

### (Additive)

The liquid crystal composition used for forming the light-absorbing anisotropic layer may further contain an additive such as a solvent, a vertical alignment agent, an interface improver, a leveling agent, a polymerizable component, a polymerization initiator (for example, a radical polymerization initiator), and a durability improver. Known additives can be appropriately used as the additive.

The viewing angle control system according to the embodiment of the present invention may include other layers different from the light-absorbing anisotropic layer and layers described later. Here, other layers are layers which are in direct contact with the light-absorbing anisotropic layer or in indirect contact with the light-absorbing anisotropic layer through a layer different from the light-absorbing anisotropic layer and layers described below. Hereinafter, the other layers which are in direct or indirect contact with the light-absorbing anisotropic layer will be described.

### (Base Material Layer)

The viewing angle control system according to the embodiment of the present invention may include a base material layer as the other layers.

The base material layer is not particularly limited, but a transparent film or sheet is preferable; and examples thereof include known transparent resin films, transparent resin plates, transparent resin sheets, and glass. As the transparent resin film, a cellulose acylate film (such as a cellulose triacetate film, a cellulose diacetate film, a cellulose acetate butyrate film, and a cellulose acetate propionate film), a polyethylene terephthalate film, a polyether sulfone film, a polyacrylic resin film, a polyurethane-based resin film, a polyester film, a polycarbonate film, a polysulfone film, a polyether film, a polymethylpentene film, a polyetherketone film, a (meth)acrylonitrile film, or the like can be used.

Among these, a cellulose acylate film which is highly transparent, has a small optical birefringence, is easily produced, and is typically used as a protective film of a polarizer is preferable, and a cellulose triacetate film is particularly preferable.

A thickness of the transparent resin film is preferably 20 μm to 100 μm.

### (Alignment Film)

The viewing angle control system according to the embodiment of the present invention may include an alignment film between the base material layer and the light-absorbing anisotropic layer as the other layers.

The alignment film may be any layer as long as the dichroic substance (liquid crystal compound) can be in a desired alignment state on the alignment film.

For example, a film formed of a polyfunctional acrylate compound or polyvinyl alcohol may be used. In particular, polyvinyl alcohol is preferable.

The alignment film may be a photo-alignment film. In addition, by irradiating a photo-alignment film containing an azo compound or a cinnamoyl compound with UV light from an oblique direction, the dichroic substance can be aligned in a state of being inclined with respect to a normal direction of the film.

### (Barrier Layer)

The viewing angle control system according to the embodiment of the present invention may include a barrier layer as the other layers.

Here, the barrier layer is also referred to as a gas-shielding layer (oxygen-shielding layer), and has a function of protecting the light-absorbing anisotropic layer from gas such as oxygen in the atmosphere, the moisture, or the compound contained in an adjacent layer.

The barrier layer can refer to, for example, the description in paragraphs [0014] to [0054] of JP2014-159124A, paragraphs [0042] to [0075] of JP2017-121721A, paragraphs [0045] to [0054] of JP2017-115076A, paragraphs [0010] to [0061] of JP2012-213938A, and paragraphs [0021] to [0031] of JP2005-169994A.

### (Refractive Index-Adjusting Layer)

In the light-absorbing anisotropic layer, internal reflection due to a high refractive index of the light-absorbing anisotropic layer may be a problem. In that case, a refractive index-adjusting layer may be used. The refractive index-adjusting layer is preferably a layer which is disposed to be in contact with the light-absorbing anisotropic layer and is for so-called index matching. An in-plane average refractive index of the refractive index-adjusting layer at a wavelength of 550 nm is preferably 1.55 or more and 1.70 or less.

### (Method for Forming Light-Absorbing Anisotropic Layer)

A method of forming the light-absorbing anisotropic layer is not particularly limited, and examples thereof include a method including, in the following order, a step of applying a composition for forming a light-absorbing anisotropic layer to form a coating film (hereinafter, also referred to as “coating film forming step”) and a step of aligning the liquid crystalline component or the dichroic substance, contained in the coating film (hereinafter, also referred to as “alignment step”).

In a case where the above-described dichroic substance has liquid crystallinity, the liquid crystalline component is a component which also includes the dichroic substance having liquid crystallinity, in addition to the above-described liquid crystal compound.

### —Coating Film Forming Step—

The coating film forming step is a step of applying the composition for forming a light-absorbing anisotropic layer to form a coating film.

The composition for forming a light-absorbing anisotropic layer can be easily applied by using a composition for forming a light-absorbing anisotropic layer, which contains a solvent, or using a liquid such as a melt obtained by heating the composition for forming a light-absorbing anisotropic layer.

Specific examples of the method of applying the composition for forming a light-absorbing anisotropic layer include known methods such as a roll coating method, a gravure printing method, a spin coating method, a wire bar coating method, an extrusion coating method, a direct gravure coating method, a reverse gravure coating method, a die-coating method, a spraying method, and an inkjet method.

### —Alignment Step—

The alignment step is a step of aligning the liquid crystalline component contained in the coating film. In this manner, the light-absorbing anisotropic layer is obtained.

The alignment step may include a drying treatment. Components such as a solvent can be removed from the coating film by performing the drying treatment. The drying treatment may be performed by a method of allowing the coating film to stand at room temperature for a predetermined time (for example, natural drying) or a method of heating the coating film and/or blowing air to the coating film.

Here, the liquid crystalline component contained in the composition for forming a light-absorbing anisotropic layer may be aligned by the coating film forming step or the drying treatment described above. For example, in an aspect in which the composition for forming a light-absorbing anisotropic layer is prepared as a coating liquid containing a solvent, a coating film having light absorption anisotropy (that is, a light-absorbing anisotropic layer) is obtained by drying the coating film and removing the solvent from the coating film.

In a case where the drying treatment is performed at a temperature equal to or higher than a transition temperature of the liquid crystalline component contained in the coating film from a liquid crystal phase to an isotropic phase, a heat treatment described below may not be performed.

From the viewpoint of manufacturing suitability or the like, a transition temperature of the liquid crystalline component contained in the coating film from the liquid crystal phase to the isotropic phase is preferably 10° C. to 250° C. and more preferably 25° C. to 190° C. In a case where the transition temperature is 10° C. or higher, a cooling treatment or the like for lowering the temperature to a temperature range in which the liquid crystal phase is exhibited is not necessary, which is preferable. In addition, in a case where the transition temperature is 250° C. or lower, a high temperature is not required even in a case where the coating film is heated until the phase transition to the isotropic phase is made for the purpose of suppressing alignment defects and waste of thermal energy and deformation and deterioration of the substrate can be reduced, which is preferable.

It is preferable that the alignment step includes a heat treatment. In this manner, since the liquid crystalline component contained in the coating film can be aligned, the coating film after being subjected to the heat treatment can be suitably used as the light-absorbing anisotropic layer.

From the viewpoint of the manufacturing suitability or the like, the heat treatment is performed at a temperature of preferably 10° C. to 250° C. and more preferably 25° C. to 190° C. In addition, the heating time is preferably 1 to 300 seconds and more preferably 1 to 60 seconds.

The alignment step may include a cooling treatment performed after the heat treatment. The cooling treatment is a treatment of cooling the heated coating film to room temperature (20° C. to 25° C.). In this manner, the alignment of the liquid crystalline component contained in the coating film can be fixed. A cooling unit is not particularly limited, and the cooling treatment can be performed according to a known method.

### —Other Steps—

The method of forming the light-absorbing anisotropic layer may include a step of curing the light-absorbing anisotropic layer after the above-described alignment step (hereinafter, also referred to as “curing step”).

The curing step is performed by heating the light-absorbing anisotropic layer and/or irradiating the light-absorbing anisotropic layer with light (exposing the light-absorbing anisotropic layer to light), for example, in a case where the compound contained in the light-absorbing anisotropic layer has a crosslinkable group (polymerizable group). Among these, from the viewpoint of productivity, it is preferable that the curing step is performed by irradiating the light absorption anisotropic film with light.

Various light sources such as infrared rays, visible light, and ultraviolet rays can be used as a light source for the curing, but ultraviolet rays are preferable. In addition, ultraviolet rays may be applied while the light-absorbing anisotropic layer is heated during the curing, or ultraviolet rays may be applied through a filter which transmits only a specific wavelength.

In a case where the exposure is performed while the light absorption anisotropic film is heated, the heating temperature during the exposure depends on the transition temperature of the liquid crystalline component contained in the liquid crystal film, but it is preferably 25° C. to 140° C.

In addition, the exposure may be performed under a nitrogen atmosphere. In a case where the curing of the liquid crystal film proceeds by radical polymerization, since inhibition of polymerization by oxygen is reduced, it is preferable that the exposure is performed in a nitrogen atmosphere.

The light-absorbing anisotropic layer may be a layer which contains the dichroic coloring agent and a guest-host liquid crystal material and can electrically drive the alignment direction of the dichroic coloring agent, as described in, for example, JP2013-541727A. In this case, it is possible to electrically switch the alignment direction of the dichroic coloring agent.

### [Liquid Crystal Cell]

The liquid crystal cell included in the viewing angle control system according to the embodiment of the present invention is disposed between the light-absorbing anisotropic layer and the polarizer, and the alignment direction of the liquid crystal compound included in the liquid crystal cell is controlled to switch between the light shielding mode and the transmission mode.

The liquid crystal cell is not particularly limited as long as the light shielding mode and the transmission mode can be switched, and a known liquid crystal cell can be used. The liquid crystal cell may have a plurality of regions where the alignment direction of the liquid crystal compound can be controlled. In a case where the liquid crystal cell has a plurality of regions where the alignment direction of the liquid crystal compound can be controlled, the alignment direction of the liquid crystal compound in each region can be controlled independently, and the light shielding mode and the transmission mode can be switched for a region of the display panel corresponding to each region.

A type of the liquid crystal cell is not particularly limited, and a known type can be used. Examples of the type of the liquid crystal cell include a twisted nematic (TN) type, a vertical alignment (VA) type, an electrically controlled birefringence (ECB) type, and an optically compensated bend (OCB) type, in addition to the above-described IPS type.

In addition, the type of the liquid crystal cell may be a super twisted nematic (STN) type having a twist angle of 180° or more, or a vertically aligned twisted nematic (VATN) type in which rod-like liquid crystal molecules are substantially vertically aligned in a state in which no voltage is applied and the liquid crystal layer is twisted and aligned at 60° to 120° in a state in which a voltage is applied, which is described in JP1998-123576A (JP-H10-123576A).

Among these, the type of the liquid crystal cell is preferably selected from the group consisting of the TN type, the IPS type, the ECB type, and the VA type; and the IPS type is preferable.

In the TN type liquid crystal cell, rod-like liquid crystal molecules are substantially horizontally aligned in a case where no voltage is applied, and further twisted and aligned at 60° to 120° along the thickness direction. The TN type liquid crystal cell is most likely used as a color thin film transistor (TFT) liquid crystal display device, and is described in many documents.

In the VA type liquid crystal cell, rod-like liquid crystalline molecules are substantially vertically aligned in a case where no voltage is applied. The VA type liquid crystal cell includes (1) a VA type liquid crystal cell in a narrow sense where rod-like liquid crystalline molecules are aligned substantially vertically at the time of no voltage application and substantially horizontally at the time of voltage application (described in JP1990-176625A (JP-H2-176625A)), (2) a (MVA type) liquid crystal cell (SID97, described in Digest of tech. Papers (proceedings) 28 (1997) 845) in which the VA type is formed to have multi-domain, (3) a (n-ASM type) liquid crystal cell in a type in which rod-like liquid crystalline molecules are substantially vertically aligned at the time of no voltage application and twistedly multi-domain aligned at the time of voltage application (described in proceedings of Japanese Liquid Crystal Conference, pp. 58 to 59 (1998)), and (4) a SURVIVAL type liquid crystal cell (presented at LCD International 98). In addition, the liquid crystal cell may be of any of a patterned vertical alignment (PVA) type, a photo-alignment (optical alignment) type, or a polymer-sustained alignment (PSA) type. Details of these types are described in JP2006-215326A and JP2008-538819A.

In the IPS type liquid crystal cell, rod-like liquid crystal molecules are substantially aligned parallel to a substrate, and a voltage is applied between electrodes to generate an electric field parallel to a surface of the substrate, so that the liquid crystal molecules respond planarly.

In the ECB type liquid crystal cell, an electric field in a direction perpendicular to the substrate surface is generated, and the arrangement direction of the liquid crystal molecules is changed by the electric field. The ECB type liquid crystal cell is generally a type in which the liquid crystal molecules are arranged along the thickness direction of the cell in a case where the electric field is generated.

In a case where the liquid crystal cell is of the IPS type, an in-plane retardation (Re(550)) of the liquid crystal cell is preferably 100 to 500 nm and more preferably 120 to 450 nm.

In addition, in a case where the liquid crystal cell is of the IPS type, the alignment direction of the liquid crystal compound can be controlled in the in-plane direction, and it is preferable that an angle formed by an absorption axis of the polarizer described later and an in-plane slow axis of the liquid crystal cell can be controlled to at least 0° to 5° or 85° to 95°. In a case where the alignment direction of the liquid crystal compound is controlled within the above-described range, it is possible to emit light from the liquid crystal cell without changing a polarization state of the light emitted from the polarizer.

In a case where the liquid crystal cell is of the IPS type, as the polarization direction of the light emitted from the polarizer is changed by the liquid crystal cell, the angle formed by the absorption axis of the polarizer and the in-plane slow axis of the liquid crystal cell can be appropriately adjusted according to the value of the in-plane retardation of the liquid crystal cell. In a case of changing the above-described polarization direction, it is preferable that the angle formed by the absorption axis of the polarizer and the in-plane slow axis of the liquid crystal cell can be controlled to 15° to 75°, and it is more preferable that the angle can be controlled to 20° to 70°. From the viewpoint of being more excellent in at least one of the light shielding properties or the transmittance properties, the above-described angle is more preferably 20° to 40° or 50° to 70°, and particularly preferably 20° to 30° or 60° to 70°.

In a case where the liquid crystal cell is of the IPS type, it is preferable to satisfy the following requirement 1 or requirement 2.

Requirement 1: An in-plane retardation (Re(550)) of the IPS type liquid crystal cell at a wavelength of 550 nm is 300 to 450 nm.

Requirement 2: The IPS type liquid crystal cell can be switched between two states; and in one state of the two states, the angle formed by the in-plane slow axis of the liquid crystal cell and the absorption axis of the polarizer is 0° to 5° or 85° to 95°, and in the other state of the two states, the angle formed by the in-plane slow axis of the liquid crystal cell and the absorption axis of the polarizer is 20° to 35°.

In a case where the liquid crystal cell is of the VA type or the ECB type, it is preferable to satisfy the following requirement 3 and requirement 4. In addition, it is more preferable to satisfy the following requirement 3, requirement 4, and requirement 5.

Requirement 3: Δnd of the liquid crystal cell of the VA type or the ECB type at a wavelength of 550 nm is 500 to 900 nm.

Requirement 4: The liquid crystal cell of the VA type or the ECB type can be switched between two states; and in one state of the two states, the angle formed by the in-plane slow axis of the liquid crystal cell and the absorption axis of the polarizer is 0° to 10°.

Requirement 5: In one state of the two states in the requirement 4, a voltage of the liquid crystal cell is 1.5 to 3.5 V, and in the other state of the two states, the voltage is OFF.

The liquid crystal cell may be controlled to be in an intermediate state between the light shielding mode and the transmission mode (intermediate halftone display). That is, in the liquid crystal cell, the alignment direction of the liquid crystal compound may be controlled to an intermediate state between the alignment direction of the liquid crystal compound in the light shielding mode and the alignment direction of the liquid crystal compound in the transmission mode.

In a case of the intermediate halftone display, since the liquid crystal compound is aligned in a predetermined direction, a magnitude of birefringence generated by the liquid crystal compound in the alignment direction and in a direction orthogonal to the alignment direction differs in a case of being observed from an oblique direction, and thus the brightness and the tone may differ. Here, a structure in which a region (for example, a region corresponding to a single pixel of the display panel) where the alignment direction of the liquid crystal compound of the liquid crystal cell can be controlled is further divided into a plurality of regions may be used as a multi-domain. In a case of the multi-domain, viewing angle characteristics of the brightness and the tone are averaged, and a difference in the brightness and the tone is easily reduced.

Specifically, by configuring each of the above-described regions (for example, the regions corresponding to a single pixel) of the liquid crystal cell with two or more regions in which the initial alignment states of the liquid crystal molecules are different from each other and averaging the regions, bias of the brightness and the tone depending on the viewing angle can be reduced. In addition, the same effect can be obtained by configuring each of the above-described regions with two or more regions which are different from each other in which the alignment direction of the liquid crystal compound continuously changes in a voltage applied state.

In any of the liquid crystal cells of the above-described type modes, the structure in which the region (for example, the region corresponding to a single pixel) of the liquid crystal cell is divided into a plurality of regions may be used as the multi-domain. In a case of the multi-domain, the viewing angle characteristics in the up-down direction and the left-right direction are averaged, and the display quality is improved, which is preferable.

### [Optical Compensation Layer]

The viewing angle control system according to the embodiment of the present invention includes the optical compensation layer in at least one of the space between the light-absorbing anisotropic layer and the liquid crystal cell or the space between the liquid crystal cell and the polarizer.

It is preferable that the optical compensation layer exhibits a thickness direction retardation (Rth). The absolute value of Rth of the optical compensation layer is preferably 50 nm or more, and more preferably 100 nm or more. The absolute value of Rth of the optical compensation layer is preferably 600 nm or less, and more preferably 500 nm or less.

In addition, an in-plane direction phase retardation (Re) of the optical compensation layer is preferably 0 nm or more, and more preferably 3 nm or more. In addition, Re of the optical compensation layer is preferably 300 nm or less, and more preferably 250 nm or less.

Furthermore, an Nz factor of the optical compensation layer is preferably −100 to 100 and more preferably −75 to 75. Here, the Nz factor means a value represented by Nz=(nx−nz)/(nx−ny).

As the optical compensation layer, an A-plate, a B-plate, or a C-plate is preferable, a B-plate or a C-plate is more preferable, and a B-plate is still more preferable.

The A-plate consists of two kinds of a positive A-plate (A-plate having a positive value; +A-plate) and a negative A-plate (A-plate having a negative value; −A-plate). In a case where a refractive index in an in-plane slow axis direction of a film is represented by nx, a refractive index in a direction orthogonal to the in-plane slow axis in the plane is represented by ny, and a refractive index in a thickness direction is represented by nz, the positive A-plate satisfies a relationship represented by Expression (A1), and the negative A-plate satisfies a relationship represented by Expression (A2). The positive A-plate has an Rth showing a positive value and the negative A-plate has an Rth showing a negative value. The in-plane slow axis direction of the film is a direction in which the in-plane refractive index is the maximum.

$$n x > ny \approx nz \qquad Expression ( A1 )$$

$$ny < nx \approx nz \qquad Expression ( A2 )$$

The symbol “≈” encompasses not only a case where both sides are completely the same as each other but also a case where the both sides are substantially the same as each other. The expression “substantially the same” means that, for example, a case where (ny−nz)×d is −10 to 10 nm and preferably −5 to 5 nm is also included in “ny≈nz”; and a case where (nx−nz)×d is −10 to 10 nm and preferably −5 to 5 nm is also included in “nx≈nz”. In (ny−nz)×d, d represents a thickness of the film.

In the B-plate, values of nx, ny, and nz are all different from each other. In addition, the B-plate consists of two kinds of a negative B-plate which has an Rth showing a negative value and satisfies a relationship represented by Expression (B1) and a positive B-plate has an Rth showing a positive value and satisfies a relationship represented by Expression (B2).

$$( nx + ny ) / 2 > nz \qquad Expression ( B1 )$$

$$( nx + ny ) / 2 < nz \qquad Expression ( B2 )$$

The C-plate consists of two kinds of a positive C-plate (C-plate having a positive value; +C-plate) and a negative C-plate (C-plate having a negative value; −C-plate). The positive C-plate satisfies a relationship represented by Expression (C1) and the negative C-plate satisfies a relationship represented by Expression (C2). The positive C-plate has an Rth showing a negative value and the negative C-plate has an Rth showing a positive value.

$$nz > nx \approx ny \qquad Expression ( C1 )$$

$$nz < nx \approx ny \qquad Expression ( C2 )$$

The symbol “≈” encompasses not only a case where both sides are completely the same as each other but also a case where the both sides are substantially the same as each other. The expression “substantially the same” means that, for example, a case where (nx−ny)×d is 0 to 10 nm and preferably 0 to 5 nm is also included in “nx≈ny”. In (ny−nz)×d, d represents a thickness of the film.

The values of Re, Rth, and the Nz factor of the optical compensation layer can be appropriately adjusted depending on the characteristics of the liquid crystal cell to be used. Hereinafter, aspects (first to ninth aspects) of a preferred combination of the characteristics of the liquid crystal cell to be used and the characteristics of the optical compensation layer will be described.

It should be noted that, in each aspect described below, only the values of Re and the Nz factor are shown, but the following relationship is established between Rth, Re, and the Nz factor. It should be noted that, in the following expression, Nz represents a value of the Nz factor.

$$Rth = Re ( Nz - 0.5 )$$

### (First Aspect)

The first aspect is an aspect in which the liquid crystal cell is of the IPS type and Re of the liquid crystal cell is 250 to 300 nm. In the liquid crystal cell of the first aspect, the angle formed by the absorption axis of the polarizer described later and the in-plane slow axis of the liquid crystal cell can be controlled to a state of 85° to 95° and a state of 40° to 50°.

In the first aspect, it is preferable that the optical compensation layer satisfies the following relationships (1A) and (1B), and it is more preferable that the optical compensation layer satisfies the following relationships (1C) and (1D).

$$125 nm \leq Re \leq 250 nm \qquad ( 1 A )$$

$$- 0.2 \leq Nz \leq 1.6 \qquad ( 1 B )$$

$$175 nm \leq Re \leq 250 nm \qquad ( 1 C )$$

$$- 0.2 \leq Nz \leq 1.2 \qquad ( 1 D )$$

### (Second Aspect)

The second aspect is an aspect in which the liquid crystal cell is of the IPS type and Re of the liquid crystal cell is 250 to 300 nm. In the liquid crystal cell of the second aspect, the angle formed by the absorption axis of the polarizer described later and the in-plane slow axis of the liquid crystal cell can be controlled to a state of 85° to 95° and a state of 40° to 50°.

In the second aspect, it is preferable that the optical compensation layer satisfies the following relationships (2A) and (2B), and it is more preferable that the optical compensation layer satisfies the following relationships (2C) and (2D).

$$50 nm \leq Re \leq 200 nm \qquad ( 2 A )$$

$$2. \leq Nz \leq 8. \qquad ( 2 B )$$

$$100 nm \leq Re \leq 200 nm \qquad ( 2 C )$$

$$2. \leq Nz \leq 6.5 \qquad ( 2 D )$$

### (Third Aspect)

The third aspect is an aspect in which the liquid crystal cell is of the IPS type and Re of the liquid crystal cell is 115 to 165 nm. In the liquid crystal cell of the third aspect, the angle formed by the absorption axis of the polarizer described later and the in-plane slow axis of the liquid crystal cell can be controlled to a state of 85° to 95° and a state of 40° to 50°.

In the third aspect, it is preferable that the optical compensation layer satisfies the following relationships (3A) and (3B), and it is more preferable that the optical compensation layer satisfies the following relationships (3C) and (3D). Satisfying the relationship (3B) or (3D) means satisfying either one of the inequalities described in the following relationships.

$$0 nm \leq Re \leq 60 nm \qquad ( 3 A )$$

$$Nz \leq - 0.3 , 1.3 \leq Nz \qquad ( 3 B )$$

$$0 nm \leq Re \leq 30 nm \qquad ( 3 C )$$

$$Nz \leq - 2.8 , 3.8 \leq Nz \qquad ( 3 D )$$

### (Fourth Aspect)

The fourth aspect is an aspect in which the liquid crystal cell is of the IPS type and Re of the liquid crystal cell is 375 to 425 nm. In the liquid crystal cell of the fourth aspect, the angle formed by the absorption axis of the polarizer described later and the in-plane slow axis of the liquid crystal cell can be controlled to a state of 85° to 95° and a state of 40° to 50°.

In the fourth aspect, it is preferable that the optical compensation layer satisfies the following relationships (4A) and (4B), and it is more preferable that the optical compensation layer satisfies the following relationships (4C) and (4D). Satisfying the relationship (4B) or (4D) means satisfying either one of the inequalities described in the following relationships.

$$0 nm \leq Re \leq 125 nm \qquad ( 4 A )$$

$$Nz \leq - 0.3 , 1.3 \leq Nz \qquad ( 4 B )$$

$$0 nm \leq Re \leq 100 nm \qquad ( 4 C )$$

$$Nz \leq - 0.5 , 1.5 \leq Nz \qquad ( 4 D )$$

### (Fifth Aspect)

The fifth aspect is an aspect in which the liquid crystal cell is of the IPS type and Re of the liquid crystal cell is 250 to 300 nm. In the liquid crystal cell of the fifth aspect, the angle formed by the absorption axis of the polarizer described later and the in-plane slow axis of the liquid crystal cell can be controlled to a state of 85° to 95° and a state of 20° to 35°.

In the fifth aspect, it is preferable that the optical compensation layer satisfies the following relationships (5A) and (5B), it is more preferable that the optical compensation layer satisfies the following relationships (5C) and (5D), and it is still more preferable that the optical compensation layer satisfies the following relationships (5E) and (5F).

$$20 nm \leq Re \leq 250 nm \qquad ( 5 A )$$

$$- 5. \leq Nz \leq 10. \qquad ( 5 B )$$

$$100 nm \leq Re \leq 250 nm \qquad ( 5 C )$$

$$0.5 \leq Nz \leq 5. \qquad ( 5 D )$$

$$125 nm \leq Re \leq 250 nm \qquad ( 5 E )$$

$$0.5 \leq Nz \leq 1.5 \qquad ( 5 F )$$

### (Sixth Aspect)

The sixth aspect is an aspect in which the liquid crystal cell is of the IPS type and Re of the liquid crystal cell is 325 to 375 nm. In the liquid crystal cell of the sixth aspect, the angle formed by the absorption axis of the polarizer described later and the in-plane slow axis of the liquid crystal cell can be controlled to a state of 85° to 95° and a state of 20° to 35°.

In the sixth aspect, it is preferable that the optical compensation layer satisfies the following relationships (6A) and (6B), it is more preferable that the optical compensation layer satisfies the following relationships (6C) and (6D), and it is still more preferable that the optical compensation layer satisfies the following relationships (6E) and (6F).

$$125 nm \leq Re \leq 250 nm \qquad ( 6 A )$$

$$1.5 \leq Nz \leq 4.1 \qquad ( 6 B )$$

$$150 nm \leq Re \leq 250 nm \qquad ( 6 C )$$

$$1.5 \leq Nz \leq 3. \qquad ( 6 D )$$

$$175 nm \leq Re \leq 250 nm \qquad ( 6 E )$$

$$1.6 \leq Nz \leq 2.5 \qquad ( 6 F )$$

### (Seventh Aspect)

The seventh aspect is an aspect in which the liquid crystal cell is of the VA type or the ECB type and Δnd of the liquid crystal cell is 210 to 300 nm. In the liquid crystal cell of the seventh aspect, the angle formed by the absorption axis of the polarizer described later and the in-plane slow axis of the liquid crystal cell can be controlled to a state of 35° to 55° (horizontal alignment mode) and a state in which the alignment direction of the liquid crystal compound of the liquid crystal cell is parallel to the thickness direction of the liquid crystal cell (vertical alignment mode).

In the seventh aspect, it is preferable that the optical compensation layer satisfies the following relationships (7A) and (7B), and it is more preferable that the optical compensation layer satisfies the following relationships (7C) and (7D). In addition, it is also preferable that the following relationships (7C) and (7E) are satisfied.

$$125 nm \leq Re \leq 250 nm \qquad ( 7 A )$$

$$1.5 \leq Nz \leq 6.5 \qquad ( 7 B )$$

$$150 nm \leq Re \leq 225 nm \qquad ( 7 C )$$

$$2.5 \leq Nz \leq 4.5 \qquad ( 7 D )$$

$$2.5 \leq Nz \leq 3. \qquad ( 7 E )$$

### (Eighth Aspect)

The eighth aspect is an aspect in which the liquid crystal cell is of the VA type or the ECB type and Δnd of the liquid crystal cell is 210 to 300 nm. In the liquid crystal cell of the eighth aspect, the angle formed by the absorption axis of the polarizer described later and the in-plane slow axis of the liquid crystal cell can be controlled to a state of 35° to 55° (horizontal alignment mode) and a state in which the alignment direction of the liquid crystal compound of the liquid crystal cell is parallel to the thickness direction of the liquid crystal cell (vertical alignment mode).

In the eighth aspect, it is preferable that the optical compensation layer satisfies the following relationships (8A) and (8B), and it is more preferable that the optical compensation layer satisfies the following relationships (8C) and (8D). Satisfying the relationship (8B) or (8D) means satisfying either one of the inequalities described in the following relationships.

$$50 nm \leq Re \leq 200 nm \qquad ( 8 A )$$

$$- 7.5 \leq Nz \leq 1. \qquad ( 8 B )$$

$$75 nm \leq Re \leq 150 nm \qquad ( 8 C )$$

$$- 4. \leq Nz \leq 1. \qquad ( 8 D )$$

### (Ninth Aspect)

The ninth aspect is an aspect in which the liquid crystal cell is of the VA type or the ECB type and Δnd of the liquid crystal cell is 500 to 900 nm. In the liquid crystal cell of the ninth aspect, the angle formed by the absorption axis of the polarizer described later and the in-plane slow axis of the liquid crystal cell can be controlled to a state of 0° to 10° or 80° to 100° (horizontal alignment mode) and a state in which the alignment direction of the liquid crystal compound of the liquid crystal cell is parallel to the thickness direction of the liquid crystal cell (vertical alignment mode).

In the ninth aspect, it is preferable that the optical compensation layer satisfies the following relationships (9A) and (9B), and it is more preferable that the optical compensation layer satisfies the following relationships (9C) and (9D). In addition, it is also preferable that the following relationships (9C) and (9E) are satisfied. Satisfying the relationship (9B) or (9D) means satisfying either one of the inequalities described in the following relationships.

$$50 nm \leq Re \leq 200 nm \qquad ( 9 A )$$

$$Nz \leq - 0.5 , 1.5 \leq Nz \qquad ( 9 B )$$

$$75 nm \leq Re \leq 150 nm \qquad ( 9 C )$$

$$- 7.5 \leq Nz \leq - 1. , 2. \leq Nz \leq 8.5 \qquad ( 9 D )$$

$$2. \leq Nz \leq 2.3 \qquad ( 9 E )$$

In the ninth aspect, it is preferable that the liquid crystal cell is multi-domain. In a case where the liquid crystal cell is multi-domain, the alignment direction of the liquid crystal compound in the liquid crystal cell is different between one domain and the other domain, but the alignment direction of the liquid crystal compound may continuously change between the domains.

In a case where the optical compensation layer has an in-plane slow axis, it is preferable that an angle formed by a direction of the in-plane slow axis of the optical compensation layer and a direction of the absorption axis of the polarizer is 0°±5° or 90°±5° by adjusting the azimuthal relationship.

### [Polarizer]

The polarizer included in the viewing angle control system according to the embodiment of the present invention is not particularly limited, and a known polarizer (linear polarizer) can be used.

Examples of the linear polarizer (absorption polarizer) include a polarizer in which a dichroic substance is dyed and stretched on a polyvinyl alcohol or other polymer resins to be horizontally aligned, and a polarizer in which a dichroic substance is horizontally aligned by aligning properties of liquid crystals.

In addition, the polarizer may be a reflective polarizer, or a laminate of an absorptive polarizer and a reflective polarizer. The reflective polarizer is a polarizer which reflects one polarized light and transmits the other polarized light. The reflective polarizer has a reflection axis and a transmission axis in a plane, but since the reflection axis functions in the same manner as an absorption axis in a typical polarizer (absorption polarizer) in the sense that it does not transmit polarized light in the azimuth thereof, in the present specification, the reflection axis of the reflective polarizer can be read as the absorption axis.

### [Other Layers]

The viewing angle control system according to the embodiment of the present invention may include a layer (other layer) other than the above-described configuration.

Examples of the other layers include a protective film, a pressure-sensitive adhesive layer, an adhesive layer, a diffusion sheet, a prism sheet, and a reflective sheet. As the other layers, known layers can be adopted.

### <Image Display Device>

The image display device according to the embodiment of the present invention includes the viewing angle control system according to the embodiment of the present invention.

The image display device is not particularly limited, and examples thereof include a liquid crystal display device, an electroluminescence display device, and a plasma display device.

The image display device may be used as, for example, a crystal display, a head-up display, a head-mounted display, or the like.

The image display device according to the embodiment of the present invention may be used in combination with a configuration which is typically used in this field. For example, the image display device according to the embodiment of the present invention may be combined with a protective film, a depolarization film, an optical compensation film, and the like.

As shown in FIGS. 1 and 2, the image display device according to the embodiment of the present invention includes a viewing angle control system and a display panel. Examples of the display panel include a display panel using a liquid crystal display element, an electroluminescence display element, or a plasma display element.

In a case where the liquid crystal display element is used as the display element, a backlight may be provided, or a transmissive liquid crystal display element in which the backlight is not provided may be used.

Examples of the above-described electroluminescence display element include an organic electroluminescence (organic EL) display element, an inorganic electroluminescence (inorganic EL) display element, and a light emitting diode display element; and an organic EL display element or a light emitting diode display element is preferable.

As described above, in the image display device according to the embodiment of the present invention, the light shielding mode and the transmission mode can be switched in a case where the image is viewed from an oblique direction at a predetermined azimuth angle. In addition, the image display device according to the embodiment of the present invention has excellent light shielding properties and transmittance properties.

From the above-described characteristics, the image display device according to the embodiment of the present invention can be used as an image display device which can change visibility from an oblique direction at a predetermined azimuth angle.

For example, in a case where the image display device according to the embodiment of the present invention is applied to an in-vehicle display, as the above-described predetermined azimuth angle is set to be on the driver side, the visibility of the image displayed on the display panel can be switched in a case where the image is viewed from the driver side. It is also preferable that the above-described switching is controlled depending on a driving state of the vehicle.

In addition, the image display device according to the embodiment of the present invention can be preferably applied to an image display device for a mobile application (for example, a laptop PC, a smartphone, a tablet terminal, a portable game machine, and the like).

### EXAMPLES

Hereinafter, the present invention will be described in more detail with reference to Examples.

The materials, the amounts of materials used, the proportions, the treatment details, the treatment procedure, and the like shown in Examples below may be modified as appropriate as long as the modifications do not depart from the spirit of the present invention. Therefore, the scope of the present invention should not be construed as being limited to Examples shown below.

### Example 1

A laminate was obtained by the following procedure, and an image display device used in Example 1 was produced.

### [Production of Optical Film 1]

An optical film 1 including a light-absorbing anisotropic layer was produced by the following procedure.

### (Formation of Alignment Film Layer)

The following composition 1 for forming an alignment film was applied onto a surface of a commercially available cellulose acylate film (manufactured by FUJIFILM Corporation, trade name: FUJITAC TG60UL) using a wire bar. The support on which the coating film was formed was dried with hot air at 140° C. for 120 seconds to form an alignment film AL1, thereby obtaining a cellulose acylate film 1 with an alignment film. A film thickness of the alignment film AL1 was 1 μm.

Composition 1 for forming alignment film

| | |
|---|---|
| Polymer PA-1 shown below | 100.00 parts by mass |
| Acid generator PAG-1 shown below | 8.25 parts by mass |
| Stabilizer DIPEA shown below | 0.6 parts by mass |
| Butyl acetate | 1001.42 parts by mass |
| Methyl ethyl ketone | 250.36 parts by mass |

Polymer PA-1 (in the formulae, the numerical value described in each repeating unit denotes the content (% by mass) of each repetition unit with respect to all repeating units) 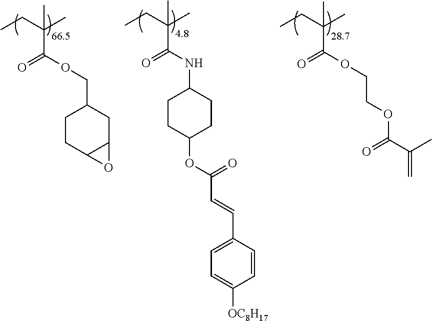
Acid generator PAG-1 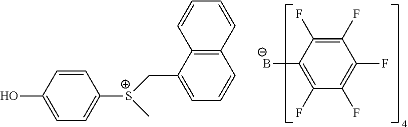
Stabilizer DIPEA

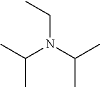

### (Formation of Light-Absorbing Anisotropic Layer A1)

The obtained cellulose acylate film 1 with an alignment film was continuously coated with the following composition P1 for forming a light-absorbing anisotropic layer using a wire bar, heated at 120° C. for 60 seconds, and cooled to room temperature (23° C.).

Next, the coating layer was heated at 85° C. for 60 seconds, and then cooled to room temperature again.

Thereafter, the coating layer was irradiated from a normal direction to the film with light for 2 seconds under an irradiation condition of illuminance of 200 mW/cm² using a LED lamp (central wavelength: 365 nm) to produce a light-absorbing anisotropic layer A1 on the alignment film AL1. A film thickness of the light-absorbing anisotropic layer A1 was 4.5 μm.

Composition P1 for forming light-absorbing anisotropic layer

| | |
|---|---|
| Dichroic substance D-1 shown below | 0.69 parts by mass |
| Dichroic substance D-2 shown below | 0.17 parts by mass |
| Dichroic substance D-3 shown below | 1.13 parts by mass |
| Polymer liquid crystal compound P-1 shown below | 8.67 parts by mass |
| Liquid crystal compound L-1 shown below | 1.97 parts by mass |
| IRGACURE OXE-02 (manufactured by BASF SE) | 0.20 parts by mass |
| Alignment agent E-1 shown below | 0.16 parts by mass |
| Alignment agent E-2 shown below | 0.16 parts by mass |
| Surfactant F-2 shown below | 0.007 parts by mass |
| Cyclopentanone | 78.17 parts by mass |
| Benzyl alcohol | 8.69 parts by mass |

Dichroic substance D-1 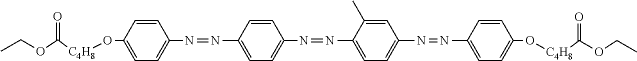
Dichroic substance D-2 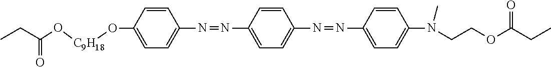
Dichroic substance D-3 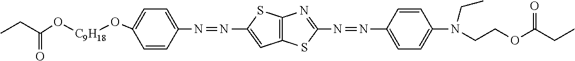
Polymer liquid crystal compound P-1 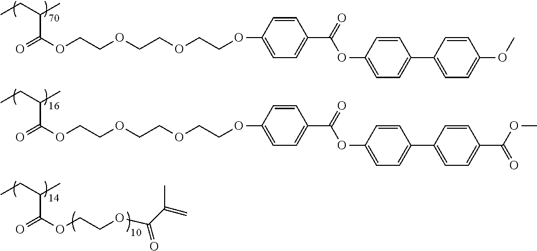
Liquid crystal compound L-1 [mixture of 84:14:2 (mass ratio) of the following liquid crystal compounds (RA), (RB), and (RC)]
(RA) 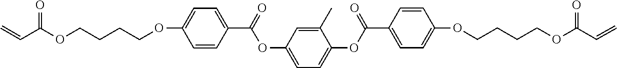 [SMILES: C=CC(=O)OCCCCOc1ccc(C(=O)Oc2ccc(OC(=O)c3ccc(OCCCCOC(=O)C=C)cc3)c(C)c2)cc1]
(RB) 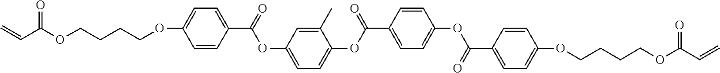 [SMILES: C=CC(=O)OCCCCOc1ccc(C(=O)Oc2ccc(C(=O)Oc3ccc(OC(=O)c4ccc(OCCCCOC(=O)C=C)cc4)cc3C)cc2)cc1]
(RC) 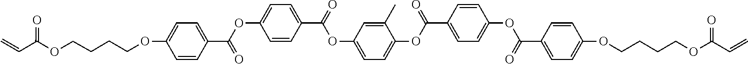 [SMILES: C=CC(=O)OCCCCOc1ccc(C(=O)Oc2ccc(C(=O)Oc3ccc(OC(=O)c4ccc(OC(=O)c5ccc(OCCCCOC(=O)C=C)cc5)cc4)c(C)c3)cc2)cc1]
Alignment agent E-1 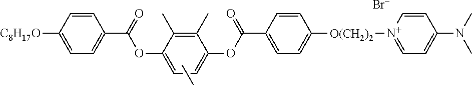
Alignment agent E-2 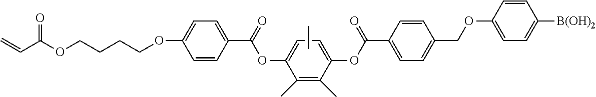
Surfactant F-2 (in the formula, TMS represents a trimethylsilyl group)

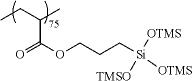

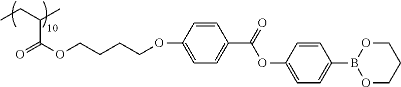

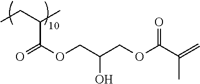

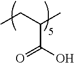

### (Formation of Protective Layer B1)

A coating film was formed by continuously coating the obtained light-absorbing anisotropic layer A1 with the following composition B1 for forming a protective layer using a wire bar.

Next, the support on which the coating film was formed was dried with hot air at 60° C. for 60 seconds, and further dried with hot air at 100° C. for 120 seconds to form a protective layer B1, thereby producing an optical film 1 including a light-absorbing anisotropic layer. A film thickness of the protective layer was 0.5 μm.

Composition B1 for forming protective layer

| | |
|---|---|
| Modified polyvinyl alcohol PVA-1 shown below | 3.80 parts by mass |
| IRGACURE 2959 | 0.20 parts by mass |
| Coloring agent compound G-1 shown below | 0.08 parts by mass |
| Water | 70 parts by mass |
| Methanol | 30 parts by mass |

Modified polyvinyl alcohol PVA-1 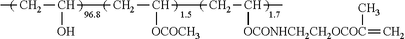
Coloring agent compound G-1

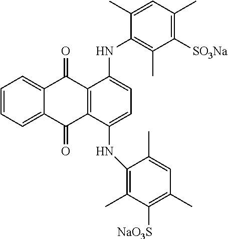

### [Production of Laminated Optical Film]

Two optical films 1 produced by the above-described procedure were prepared, and the protective layers B1 of the optical films 1 were bonded to each other using a commercially available pressure-sensitive adhesive (manufactured by Soken Chemical & Engineering Co., Ltd., SK2057) to produce a laminated optical film 1 including a light-absorbing anisotropic layer.

An azimuthal angle and a polar angle of a transmittance central axis of the laminated optical film 1 were examined by the following procedure. Using AxoScan OPMF-2 (manufactured by Axometrics, Inc.), as described above, the transmittance of the laminated optical film 1 was measured while changing the azimuthal angle and the polar angle at which light was incident on the laminated optical film 1, thereby defining the direction of the transmittance central axis of the laminated optical film 1.

An angle formed by the transmittance central axis of the laminated optical film 1 (light-absorbing anisotropic layer) and a normal line of the laminated optical film was 0°.

### [Production of Optical Compensation Layer 1]

### (Extrusion Molding)

A cycloolefin resin ARTON G7810 (manufactured by JSR Corporation) was dried at 100° C. for 2 hours or more, and melt-extruded at 280° C. using a twin screw kneading extruder. Here, a screen filter, a gear pump, and a leaf disc filter were arranged in this order between the extruder and a die, these were connected by a melt pipe, and the resultant was extruded from a T die having a width of 1000 mm and a lip gap of 1 mm and was cast on a triple cast roll in which temperatures were set to 180° C., 175° C., and 170° C., thereby obtaining an un-stretched film 1 having a width of 900 mm and a thickness of 94 μm.

### (Stretching and Thermal Fixation)

The un-stretched film 1 transported was subjected to a stretching step and a thermal fixing step by the following method.

### (a) Machine-Directional Stretching

The un-stretched film 1 was machine-directionally stretched under the following conditions while being transported using an inter-roll machine-direction stretching machine having an aspect ratio (L/W) of 0.2.

### —Condition—

Preheating temperature: 170° C.
Stretching temperature: 170° C.
Stretching ratio: 230%

### (b) Cross-Direction Stretching

The machine-directionally stretched film was cross-directionally stretched under the following conditions while being transported using a tentering machine.

### —Condition—

Preheating temperature: 170° C.
Stretching temperature: 170° C.
Stretching ratio: 10%

### (c) Thermal Fixation

After the stretching step, the stretched film was subjected to a heat treatment under the following conditions while end portions of the stretched film were gripped with a tenter clip to hold both end portions of the stretched film such that the width thereof was constant (within 3% of expansion or contraction), and the stretched film was thermally fixed.
Thermal fixation temperature: 165° C.
Thermal fixation time: 30 seconds

The preheating temperature, the stretching temperature, and the thermal fixation temperature are average values of values measured at five points in the width direction using a radiation thermometer.

### (Winding)

After the thermal fixation, both ends of the stretched film were trimmed and wound at a tension of 25 kg/m, thereby obtaining a film roll of a stretching film having a width of 1,340 mm and a winding length of 2,000 m.

Regarding the obtained stretching film, Re was 150 nm, Rth was 150 nm, and the Nz factor was 1.5. The stretching film obtained by the above-described procedure was used as an optical compensation layer 1.

### [Production of Polarizing Plate]

A polarizing plate in which a thickness of a polarizer was 8 μm and one surface of the polarizer (the other light-absorbing anisotropic layer) was exposed was produced by the same method as that for a polarizing plate 02 with a one-surface protective film, described in WO2015/166991A.

### [Production of IPS Liquid Crystal Cell 1]

An IPS liquid crystal cell having a liquid crystal layer between two glass substrates was produced. In a case of forming the liquid crystal cell, an alignment layer was formed by performing a photo-alignment treatment on the glass substrates with reference to Example 11 of JP2005-351924A, and a liquid crystal layer in which the liquid crystal compound was aligned was formed in the liquid crystal cell. A tilt angle of the liquid crystal compound with respect to a substrate surface was 0.1°. Δn of the liquid crystal compound in the liquid crystal layer was 0.08625 at a wavelength of 550 nm, and Δnd was adjusted by adjusting an interval (gap; d) between the substrates. An in-plane retardation of the liquid crystal cell 1 was 275 nm (λ/2).

An IPS liquid crystal cell 1, which was an IPS type liquid crystal cell, was obtained by the above-described procedure.

### [Production of Viewing Angle Control System 1]

The produced optical compensation layer 1 was bonded to one surface of the produced IPS liquid crystal cell 1 using a commercially available pressure-sensitive adhesive (manufactured by Soken Chemical & Engineering Co., Ltd., SK2057).

Next, the produced polarizing plate was bonded using a commercially available pressure-sensitive adhesive SK2057 (manufactured by Soken Chemical & Engineering Co., Ltd.) such that the polarizer surface and the surface of the optical compensation layer 1 opposite to the IPS liquid crystal cell 1 side were facing each other. In this case, the azimuthal relationship during bonding was adjusted such that the absorption axis of the polarizing plate and the slow axis of the optical compensation layer 1 were parallel to each other.

Next, the produced laminated optical film 1 was bonded to the surface of the IPS liquid crystal cell opposite to the surface on which the polarizing plate was bonded, using a commercially available pressure-sensitive adhesive (manufactured by Soken Chemical & Engineering Co., Ltd., SK2057), thereby obtaining a viewing angle control system 1.

In a case of the above-described bonding, the IPS liquid crystal cell 1 was installed such that the angle formed by the in-plane slow axis of the liquid crystal layer in the IPS liquid crystal cell 1 in a voltage applied state and the absorption axis of the polarizing plate was 45°, and the angle formed by the in-plane slow axis of the liquid crystal layer in the IPS liquid crystal cell 1 in a voltage non-applied state and the absorption axis of the polarizing plate was 0°.

### [Production of Image Display Device A1]

COSMOSHINE super birefringent type (SRF, registered trademark, manufactured by TOYOBO Co., Ltd.) (depolarization film) was bonded to a display screen of a notebook computer which was a dynabook (registered trademark, manufactured by Toshiba Corporation), equipped with a liquid crystal display device, using a commercially available pressure-sensitive adhesive SK2057 (manufactured by Soken Chemical & Engineering Co., Ltd.).

Next, the above-described produced viewing angle control system 1 was placed on the depolarization film to produce an image display device A1 having a viewing angle control function.

In the produced image display device A1, the angle between the in-plane slow axis of the liquid crystal layer in the IPS liquid crystal cell 1 and the absorption axis of the polarizer could be switched to 45° and 0° by turning on and off the voltage applied to the IPS liquid crystal cell 1.

In a case where the up-down direction of the image display region of the above-described notebook computer was set to an azimuthal angle of 0°, and the image display device A1 was viewed from an oblique direction at azimuthal angles of 90° and 270°, it was confirmed that the light shielding mode and the transmission mode could be switched by turning on and off the voltage applied to the IPS liquid crystal cell 1.

### Example 2

### [Production of Optical Compensation Layer 2]

In the production of the optical compensation layer 1 of Example 1, by adjusting the film thickness, the stretching temperature, and the stretching ratio, a stretching film in which Re was 200 nm, Rth was 100 nm, and the Nz factor was 1.0 was obtained. The stretching film was used as an optical compensation layer 2.

### [Production of Image Display Device A2]

An image display device A2 was produced in the same manner as in Example 1, except that the optical compensation layer 1 was changed to the above-described optical compensation layer 2 in the production of the viewing angle control system 1 of Example 1.

### Example 3

### [Production of Optical Compensation Layer 3]

In the production of the optical compensation layer 1 of Example 1, by adjusting the film thickness, the stretching temperature, and the stretching ratio, a stretching film in which Re was 65 nm, Rth was 420 nm, and the Nz factor was 7.0 was obtained. The stretching film was used as an optical compensation layer 3.

### [Production of Viewing Angle Control System 3]

The produced optical compensation layer 3 was bonded to one surface of the IPS liquid crystal cell 1 produced in Example 1 using a commercially available pressure-sensitive adhesive (manufactured by Soken Chemical & Engineering Co., Ltd., SK2057).

Next, the laminated optical film 1 including the light-absorbing anisotropic layer produced in Example 1 was bonded to the surface of the bonded optical compensation layer 3 opposite to the IPS liquid crystal cell 1 side, using a commercially available pressure-sensitive adhesive SK2057 (manufactured by Soken Chemical & Engineering Co., Ltd.).

Next, the polarizing plate produced in Example 1 was bonded to the surface of the IPS liquid crystal cell 1 opposite to the surface on which the optical compensation layer 3 was bonded, using a commercially available pressure-sensitive adhesive (manufactured by Soken Chemical & Engineering Co., Ltd., SK2057), thereby producing a viewing angle control system 3. In this case, the optical compensation layer 3 was bonded such that the absorption axis of the polarizing plate and the slow axis of the optical compensation layer 3 were parallel to each other.

In a case of the above-described bonding, the IPS liquid crystal cell 1 was installed such that the angle formed by the in-plane slow axis of the liquid crystal layer in the IPS liquid crystal cell 1 in a voltage applied state and the absorption axis of the polarizing plate was 45°, and the angle formed by the in-plane slow axis of the liquid crystal layer in the IPS liquid crystal cell 1 in a voltage non-applied state and the absorption axis of the polarizing plate was 0°.

### [Production of Image Display Device A3]

An image display device A3 was produced in the same manner as in Example 1, except that the viewing angle control system 1 was changed to the above-described viewing angle control system 3 in the production of the viewing angle control system 1 of Example 1.

### Example 4

### [Production of Optical Compensation Layer 4]

In the production of the optical compensation layer 1 of Example 1, by adjusting the film thickness, the stretching temperature, and the stretching ratio, a stretching film in which Re was 120 nm, Rth was 420 nm, and the Nz factor was 4.0 was obtained. The stretching film was used as an optical compensation layer 4.

### [Production of Image Display Device A4]

An image display device A4 was produced in the same manner as in Example 3, except that the optical compensation layer 3 was changed to the above-described optical compensation layer 4 in the production of the viewing angle control system 3 of Example 3.

### Comparative Example 1

### [Production of Image Display Device B1]

An image display device B1 was produced in the same manner as in the image display device A1, except that the optical compensation layer 1 was not bonded in the production of the image display device A1 of Example 1.

### Example 5

### [Production of Optical Compensation Layer 5]

In the production of the optical compensation layer 1 of Example 1, by adjusting the film thickness, the stretching temperature, and the stretching ratio, a stretching film in which Re was 50 nm, Rth was 100 nm, and the Nz factor was 2.5 was obtained. The stretching film was used as an optical compensation layer 5.

### [Production of IPS Liquid Crystal Cell 5]

An IPS liquid crystal cell 5 was produced in the same manner as in Example 1, except that, in the production of the IPS liquid crystal cell 1 of Example 1, the in-plane retardation of the liquid crystal layer was set to 140 nm (λ/4) by adjusting the interval (gap; d) of the substrates.

### [Production of Image Display Device A5]

An image display device A5 was produced in the same manner as in Example 1, except that, in the production of the viewing angle control system 1 of Example 1, the optical compensation layer 1 was changed to the optical compensation layer 5 produced as described above, and the IPS liquid crystal cell 1 was changed to the above-described IPS liquid crystal cell 5.

In the produced image display device A5, the angle between the in-plane slow axis of the liquid crystal layer in the IPS liquid crystal cell 5 and the absorption axis of the polarizer could be switched to 45° and 0° by turning on and off the voltage applied to the IPS liquid crystal cell 5.

In a case where the up-down direction of the image display region of the above-described notebook computer was set to an azimuthal angle of 0°, and the image display device A5 was viewed from an oblique direction at azimuthal angles of 90° and 270°, it was confirmed that the light shielding mode and the transmission mode could be switched by turning on and off the voltage applied to the IPS liquid crystal cell 5.

### Example 6

### [Production of Optical Compensation Layer 6]

A composition for forming an optical compensation layer 6 shown below was prepared to obtain a uniform solution.

Composition for forming optical compensation layer 6

| | |
|---|---|
| Discotic liquid crystal compound CA-1 | 80 parts by mass |
| Discotic liquid crystal compound CA-2 | 20 parts by mass |
| Discotic liquid crystal compound CB-1 | 5.6 parts by mass |
| Polymerizable monomer CS1 | 5.6 parts by mass |
| Polymer CC-1 | 0.2 parts by mass |
| Polymerization initiator (IRGACURE 907, manufactured by BASF SE) | 3 parts by mass |
| Toluene | 170 parts by mass |
| Methyl ethyl ketone | 73 parts by mass |

Discotic liquid crystal compound CA-1 (1,3,5-substituted benzene type polymerizable discotic liquid crystal compound) 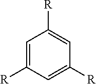 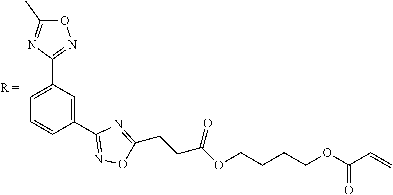 [SMILES: C=CC(=O)OCCCCOC(=O)CCc1nc(-c2cccc(-c3noc(C)n3)c2)no1]
Discotic liquid crystal compound CA-2 (1,3,5-substituted benzene type polymerizable discotic liquid crystal compound) 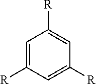 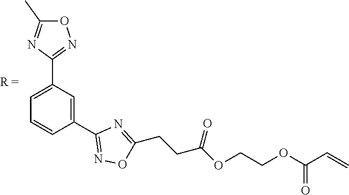 [SMILES: C=CC(=O)OCCOC(=O)CCc1nc(-c2cccc(-c3noc(C)n3)c2)no1]
Discotic liquid crystal compound CB-1 (polymerizable triphenylene type discotic liquid crystal compound) 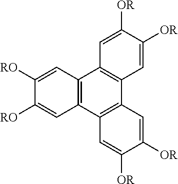 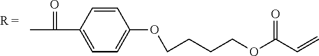 [SMILES: C=CC(=O)OCCCCOc1ccc(C(C)=O)cc1]
Polymerizable monomer CS1 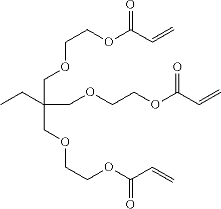 [SMILES: C=CC(=O)OCCOCC(CC)(COCCOC(=O)C=C)COCCOC(=O)C=C]
Polymer CC-1 (hereinafter, the copolymerization ratio of the chemical structural formula is in units of % by mass)

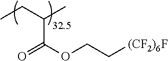

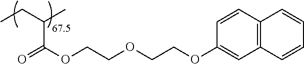

A commercially available cellulose triacetate film (FUJITAC ZRD40, manufactured by FUJIFILM Corporation) subjected to a saponification treatment was used as a support. The above-described composition for forming an optical compensation layer 6 was applied onto the surface of the support, the solvent was dried in a step of continuously heating the support from room temperature to 100° C., and the coating film was further heated at 100° C. for approximately 90 seconds in a drying zone. Thereafter, the temperature was lowered to 60° C., and the coating film was cured by performing UV exposure of 300 mJ/cm² in the air to form a cured film. In a case where the alignment state of the cured film was observed after the cured film was allowed to be naturally cooled to room temperature, it was found that the discotic liquid crystal compound was horizontally aligned without any defects.

Regarding the obtained laminated film of the cured film and the support, Re was 3 nm, Rth was 200 nm, and the Nz factor was 67.2. The above-described laminated film was used as an optical compensation layer 6.

### [Production of Image Display Device A6]

An image display device A6 was produced in the same manner as in Example 5, except that the optical compensation layer 5 was changed to the above-described optical compensation layer 6 in the production of the viewing angle control system 5 of Example 5.

### Example 7

### [Production of Optical Compensation Layer 7]

In the production of the optical compensation layer 1 of Example 1, by adjusting the film thickness, the stretching temperature, and the stretching ratio, a stretching film in which Re was 75 nm, Rth was 150 nm, and the Nz factor was 2.5 was obtained. The stretching film was used as an optical compensation layer 7.

### [Production of IPS Liquid Crystal Cell 7]

An IPS liquid crystal cell 7 was produced in the same manner as in Example 1, except that, in the production of the IPS liquid crystal cell 1 of Example 1, the in-plane retardation of the liquid crystal layer was set to 400 nm by adjusting the interval (gap; d) of the substrates.

### [Production of Image Display Device A7]

An image display device A7 was produced in the same manner as in Example 5, except that, in the production of the viewing angle control system 5 of Example 5, the optical compensation layer 5 was changed to the above-described optical compensation layer 7, and the IPS liquid crystal cell 5 was changed to the above-described IPS liquid crystal cell 7.

### Example 8

### [Production of Optical Compensation Layer 8]

A composition for forming an optical compensation layer 8 produced as shown in the table below was applied onto a cellulose acylate film (TAC substrate; manufactured by FUJIFILM Corporation, TG40) after saponification treatment, having a thickness of 40 μm, using a wire bar to form a coating film. The coating film was heated with hot air at 40° C. for 60 seconds for drying the solvent of the composition of the coating film and for aligning and aging the liquid crystal compound. Subsequently, the coating film was irradiated with ultraviolet rays (300 mJ/cm²) at 40° C. in a nitrogen purge atmosphere (oxygen concentration: 100 ppm) to fix the alignment of the liquid crystal compound, thereby forming a cured film.

Regarding the obtained laminated film of the cured film and the support, Re was 4 nm, Rth was −300 nm, and the Nz factor was −74.5. The above-described laminated film was used as an optical compensation layer 8.

Composition for forming optical compensation layer 8

| | |
|---|---|
| Rod-like liquid crystal compound-1 shown below | 83 parts by mass |
| Rod-like liquid crystal compound-2 shown below | 15 parts by mass |
| Rod-like liquid crystal compound-3 shown below | 2 parts by mass |
| Polymerizable monomer (M-1) shown below | 8 parts by mass |
| Polymerization initiator (Irgacure 127, manufactured by BASF SE) | 2 parts by mass |
| Polymerization initiator (Irgacure OXE01, manufactured by BASF SE) | 4 parts by mass |
| Surfactant F-1 shown below | 0.18 parts by mass |
| Surfactant F-2 shown below | 0.24 parts by mass |
| Onium compound S01 shown below | 2 parts by mass |
| Polymer compound A-1 shown below | 5 parts by mass |
| Toluene | 621 parts by mass |
| Methyl ethyl ketone | 69 parts by mass |

Rod-like liquid crystal compound-1 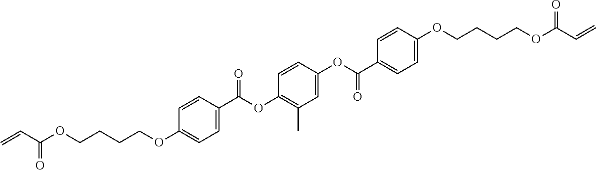 [SMILES: C=CC(=O)OCCCCOc1ccc(C(=O)Oc2ccc(OC(=O)c3ccc(OCCCCOC(=O)C=C)cc3)c(C)c2)cc1]
Rod-like liquid crystal compound-2 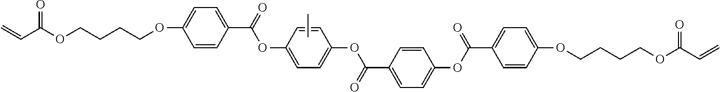
Rod-like liquid crystal compound-3 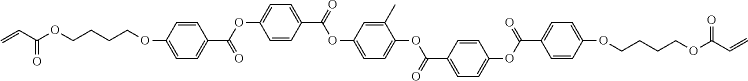 [SMILES: C=CC(=O)OCCCCOc1ccc(C(=O)Oc2ccc(C(=O)Oc3ccc(OC(=O)c4ccc(OC(=O)c5ccc(OCCCCOC(=O)C=C)cc5)cc4)c(C)c3)cc2)cc1]
Polymerizable monomer (M-1) 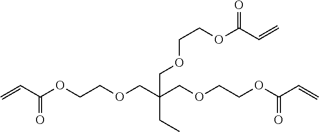 [SMILES: C=CC(=O)OCCOCC(CC)(COCCOC(=O)C=C)COCCOC(=O)C=C]
Surfactant F-1 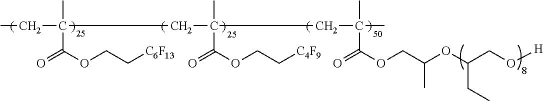
Surfactant F-2 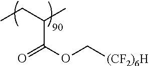 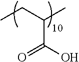
Onium compound S01 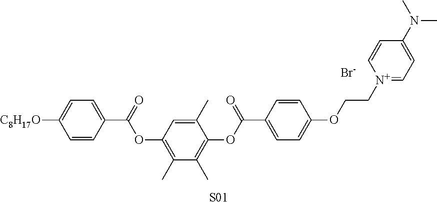
Polymer compound A-1

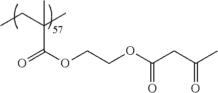

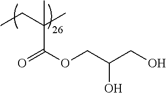

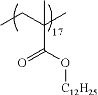

### [Production of Image Display Device A8]

An image display device A8 was produced in the same manner as in Example 7, except that the optical compensation layer 7 was changed to the above-described optical compensation layer 8 in the production of the viewing angle control system 7 of Example 7.

### Example 9

### [Production of Optical Compensation Layer 9]

In the production of the optical compensation layer 1 of Example 1, by adjusting the film thickness, the stretching temperature, and the stretching ratio, a stretching film in which Re was 75 nm, Rth was 500 nm, and the Nz factor was 7.2 was obtained. The stretching film was used as an optical compensation layer 9.

### [Production of IPS Liquid Crystal Cell 9]

An IPS liquid crystal cell 9 was produced in the same manner as in Example 1, except that, in the production of the IPS liquid crystal cell 1 of Example 1, the angle formed by the in-plane slow axis of the liquid crystal layer in a voltage ON state and the in-plane slow axis in a voltage OFF state was set to 60°.

### [Production of Image Display Device A9]

An image display device A9 was produced in the same manner as in Example 3, except that, in the production of the image display device A3 of Example 3, the IPS liquid crystal cell 1 was changed to the above-described IPS liquid crystal cell 9, and the optical compensation layer 3 was changed to the above-described optical compensation layer 9.

In the produced image display device A9, the angle between the in-plane slow axis of the liquid crystal layer in the IPS liquid crystal cell and the absorption axis of the polarizer could be switched to 60° and 0° by turning on and off the voltage applied to the IPS liquid crystal cell 9.

In a case where the up-down direction of the image display region of the above-described notebook computer was set to an azimuthal angle of 0°, and the image display device A9 was viewed from an oblique direction at azimuthal angles of 90° and 270°, it was confirmed that the light shielding mode and the transmission mode could be switched by turning on and off the voltage applied to the IPS liquid crystal cell 9.

### Example 10

### [Production of Optical Compensation Layer 10]

In the production of the optical compensation layer 1 of Example 1, by adjusting the film thickness, the stretching temperature, and the stretching ratio, a stretching film in which Re was 120 nm, Rth was 420 nm, and the Nz factor was 4.0 was obtained. The stretching film was used as an optical compensation layer 10.

### [Production of Image Display Device A10]

An image display device A10 was produced in the same manner as in Example 9, except that the optical compensation layer 9 was changed to the above-described optical compensation layer 10 in the production of the viewing angle control system 9 of Example 9.

### Example 11

### [Production of Optical Compensation Layer 11]

In the production of the optical compensation layer 1 of Example 1, by adjusting the film thickness, the stretching temperature, and the stretching ratio, a stretching film in which Re was 200 nm, Rth was 180 nm, and the Nz factor was 1.4 was obtained. The stretching film was used as an optical compensation layer 11.

### [Production of IPS Liquid Crystal Cell 11]

An IPS liquid crystal cell 11 was produced in the same manner as in Example 1, except that, in the production of the IPS liquid crystal cell 1 of Example 1, the angle formed by the in-plane slow axis of the liquid crystal layer in a voltage ON state and the in-plane slow axis in a voltage OFF state was set to 25°.

### [Production of Image Display Device A11]

An image display device A11 was produced in the same manner as in Example 5, except that, in the production of the image display device A5 of Example 5, the IPS liquid crystal cell 5 was changed to the above-described IPS liquid crystal cell 11, the optical compensation layer 5 was changed to the above-described optical compensation layer 11, and the polarizing plate was bonded such that the absorption axis of the polarizing plate and the slow axis of the optical compensation layer 11 were orthogonal to each other.

In the produced image display device A11, the angle between the in-plane slow axis of the liquid crystal layer in the IPS liquid crystal cell and the absorption axis of the polarizer could be switched to 65° and 90° by turning on and off the voltage applied to the IPS liquid crystal cell.

In a case where the up-down direction of the image display region of the above-described notebook computer was set to an azimuthal angle of 0°, and the image display device A11 was viewed from an oblique direction at azimuthal angles of 90° and 270°, it was confirmed that the light shielding mode and the transmission mode could be switched by turning on and off the voltage applied to the IPS liquid crystal cell 11.

### Example 12

### [Production of Optical Compensation Layer 12]

In the production of the optical compensation layer 1 of Example 1, by adjusting the film thickness, the stretching temperature, and the stretching ratio, a stretching film in which Re was 150 nm, Rth was 500 nm, and the Nz factor was 3.8 was obtained. The stretching film was used as an optical compensation layer 12.

### [Production of IPS Liquid Crystal Cell 12]

An IPS liquid crystal cell 12 was produced in the same manner as in Example 1, except that, in the production of the IPS liquid crystal cell 1 of Example 1, the in-plane retardation of the liquid crystal layer was set to 350 nm by adjusting the interval (gap; d) of the substrates, and the angle formed by the in-plane slow axis of the liquid crystal layer in a voltage ON state and the in-plane slow axis in a voltage OFF state was set to 65°.

### [Production of Image Display Device A12]

An image display device A12 was produced in the same manner as in Example 5, except that, in the production of the image display device A5 of Example 5, the IPS liquid crystal cell 5 was changed to the above-described IPS liquid crystal cell 12, and the optical compensation layer 5 was changed to the above-described optical compensation layer 12.

In the produced image display device A12, the angle between the in-plane slow axis of the liquid crystal layer in the IPS liquid crystal cell and the absorption axis of the polarizer could be switched to 65° and 0° by turning on and off the voltage applied to the IPS liquid crystal cell.

In a case where the up-down direction of the image display region of the above-described notebook computer was set to an azimuthal angle of 0°, and the image display device A12 was viewed from an oblique direction at azimuthal angles of 90° and 270°, it was confirmed that the light shielding mode and the transmission mode could be switched by turning on and off the voltage applied to the IPS liquid crystal cell 12.

### Example 13

### [Production of Optical Compensation Layer 13]

In the production of the optical compensation layer 1 of Example 1, by adjusting the film thickness, the stretching temperature, and the stretching ratio, a stretching film in which Re was 150 nm, Rth was 300 nm, and the Nz factor was 2.5 was obtained. The stretching film was used as an optical compensation layer 13.

### [Production of Image Display Device A13]

An image display device A13 was produced in the same manner as in Example 12, except that the optical compensation layer 12 was changed to the above-described optical compensation layer 13 in the production of the viewing angle control system 12 of Example 12.

### Example 14

### [Production of Optical Compensation Layer 14]

In the production of the optical compensation layer 1 of Example 1, by adjusting the film thickness, the stretching temperature, and the stretching ratio, a stretching film in which Re was 200 nm, Rth was 300 nm, and the Nz factor was 2.0 was obtained. The stretching film was used as an optical compensation layer 14.

### [Production of Image Display Device A14]

An image display device A14 was produced in the same manner as in Example 12, except that the optical compensation layer 12 was changed to the above-described optical compensation layer 14 in the production of the viewing angle control system 12 of Example 12.

### Comparative Example 2

### [Production of Image Display Device B2]

An image display device B2 was produced in the same manner as in the image display device A5, except that the optical compensation layer 5 was not bonded in the production of the image display device A5 of Example 5.

### Example 15

### [Production of Optical Compensation Layer 15]

In the production of the optical compensation layer 1 of Example 1, by adjusting the film thickness, the stretching temperature, and the stretching ratio, a stretching film in which Re was 200 nm, Rth was 400 nm, and the Nz factor was 2.5 was obtained. The stretching film was used as an optical compensation layer 15.

### [Production of VA Liquid Crystal Cell 13]

A glass substrate with an electrode was immersed in a solution obtained by diluting 50 cc of a household neutral detergent with water for 30 seconds, and was allowed to dry naturally. In addition, an alignment film for a liquid crystal material (“JALS-2021-R1”, manufactured by JSR Corporation) was formed on a separately cleaned glass substrate, and the formed alignment film for a liquid crystal material was subjected to a rubbing treatment. The above-described glass substrate with an electrode and the glass substrate on which the alignment film was formed were assembled into a liquid crystal cell such that the rubbed surface was on the inside. A liquid crystal cell was produced by dropping and injecting a liquid crystal material (“MLC6608”, manufactured by Merck KGaA) having negative dielectric constant anisotropy between the substrates, sealing the liquid crystal material, and forming a liquid crystal layer between the substrates to be vertically aligned. In this case, a cell gap between the substrates was adjusted such that Δnd at a wavelength of 550 nm was adjusted to 275 nm.

A VA liquid crystal cell 13, which was a liquid crystal cell of the VA type, was obtained by the above-described procedure. In the VA liquid crystal cell 13, the alignment direction of the above-described liquid crystal material (liquid crystal compound) changed from vertical alignment to horizontal alignment by applying a voltage.

### [Production of Image Display Device A15]

An image display device A15 was produced in the same manner as in Example 1, except that, in the production of the image display device A1 of Example 1, the IPS liquid crystal cell 1 was changed to the above-described VA liquid crystal cell 13, the optical compensation layer 1 was changed to the above-described optical compensation layer 15, and the polarizing plate was bonded such that the absorption axis of the polarizing plate and the slow axis of the optical compensation layer 15 were orthogonal to each other. In this case, the bonding was performed such that the angle between the alignment direction of the liquid crystal in a state of applying a voltage to the VA liquid crystal cell 13 and the absorption axis of the polarizing plate was 45°.

In the produced image display device A15, it was confirmed that the alignment direction of the liquid crystal compound changed by turning on and off the voltage (20 V) applied to the VA liquid crystal cell 13, and the light shielding mode (ON) and the transmission mode (OFF) could be switched.

### Example 16

### [Production of Optical Compensation Layer 16]

In the production of the optical compensation layer 1 of Example 1, by adjusting the film thickness, the stretching temperature, and the stretching ratio, a stretching film in which Re was 200 nm, Rth was 600 nm, and the Nz factor was 3.5 was obtained. The stretching film was used as an optical compensation layer 16.

### [Production of Image Display Device A16]

An image display device A16 was produced in the same manner as in Example 3, except that, in the production of the image display device A3 of Example 3, the IPS liquid crystal cell 1 was changed to the above-described VA liquid crystal cell 13, the optical compensation layer 3 was changed to the above-described optical compensation layer 16, and the polarizing plate was bonded such that the absorption axis of the polarizing plate and the slow axis of the optical compensation layer 16 were orthogonal to each other. In this case, the bonding was performed such that the angle between the alignment direction of the liquid crystal in a state of applying a voltage to the VA liquid crystal cell 13 and the absorption axis of the polarizing plate was 45°.

In the produced image display device A16, it was confirmed that the alignment direction of the liquid crystal compound changed by turning on and off the voltage (20 V) applied to the VA liquid crystal cell 13, and the light shielding mode (ON) and the transmission mode (OFF) could be switched.

### Example 17

### [Production of Optical Compensation Layer 17-1]

### (Formation of Alignment Film 2)

One surface of a cellulose acylate film (TAC base material; manufactured by FUJIFILM Corporation, TG40) having a thickness of 40 μm was continuously coated with the following composition 2 for forming an alignment film using a #14 wire bar. The coating was dried with hot air at 60° C. for 60 seconds, and further dried with hot air at 100° C. for 120 seconds.

Formulation of composition 2 for forming alignment film

| | |
|---|---|
| Modified polyvinyl alcohol PVA-1 shown above | 10 parts by mass |
| Water | 308 parts by mass |
| Methanol | 70 parts by mass |
| Isopropanol | 29 parts by mass |
| Photopolymerization initiator (IRGACURE 2959, | 0.8 parts by mass |
| manufactured by BASF SE) | |

### (Formation of Retardation Layer A)

The alignment film 2 produced as described above was continuously subjected to a rubbing treatment. In this case, a longitudinal direction of the elongated film was parallel to a transport direction, and an angle formed between the longitudinal direction of the film and a rotation axis of the rubbing roller was set to 90° (in a case where the width direction of the film was defined as 0°, the longitudinal direction of the film was defined as 90°, and the counterclockwise direction was expressed as a positive value with reference to the width direction of the film observed from the alignment film side, the rotation axis of the rubbing roller was 0°).

A coating liquid A for a retardation layer, containing a discotic liquid crystal compound having the following formulation, was continuously applied onto the produced alignment film 2 using a wire bar to produce a retardation layer A. In order to dry the solvent of the coating liquid and to age the alignment of the discotic liquid crystal compound, the film was heated with hot air at 130° C. for 90 seconds, further heated with hot air at 100° C. for 60 seconds, and irradiated with UV rays at 80° C. to fix the alignment of the liquid crystal compound. A thickness of the retardation layer A was 1.0 μm, and Re at 550 nm was 125 nm. It was confirmed that an average tilt angle of a disc plane of the discotic liquid crystal compound with respect to the film surface was 90°, and the discotic liquid crystal compound was vertically aligned with respect to the film surface. In addition, in a case where the angle of the slow axis of the retardation layer A was parallel to the rotation axis of the rubbing roller and the width direction of the film was defined as 0° (the longitudinal direction was 90°), the slow axis was 0° as viewed from the retardation layer A side.

Formulation of coating liquid A for retardation layer

| | |
|---|---|
| Discotic liquid crystal-1 shown below | 80 parts by mass |
| Discotic liquid crystal-2 shown below | 20 parts by mass |
| Alignment film interface alignment agent-1 shown below | 0.55 parts by mass |
| Alignment film interface alignment agent-2 shown below | 0.05 parts by mass |
| Surfactant F-4 shown below | 0.20 parts by mass |
| Modified trimethylolpropane triacrylate | 10 parts by mass |
| Photopolymerization initiator (IRGACURE 907, manufactured by BASF SE) | 3.0 parts by mass |
| Methyl ethyl ketone | 200 parts by mass |

Discotic liquid crystal-1 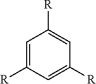 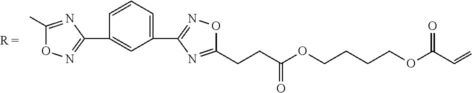 [SMILES: C=CC(=O)OCCCCOC(=O)CCc1nc(-c2cccc(-c3noc(C)n3)c2)no1]
Discotic liquid crystal-2 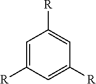 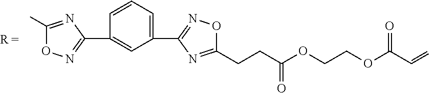 [SMILES: C=CC(=O)OCCOC(=O)CCc1nc(-c2cccc(-c3noc(C)n3)c2)no1]
Alignment film interface alignment agent-1 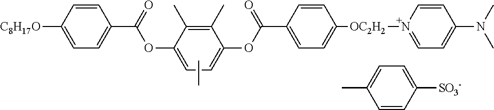
Alignment film interface alignment agent-2 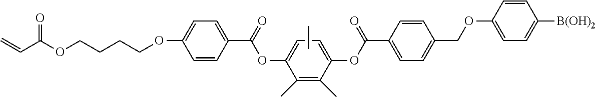
Surfactant F-4

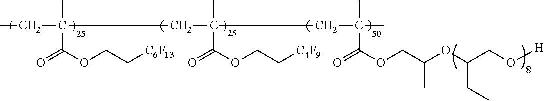

### [Production of Optical Compensation Layer 17-2]

An optical compensation layer 17-2 was produced in the same manner as in Example 8, except that, in the production of the optical compensation layer 8 of Example 8, the composition for forming an optical compensation layer 8 was changed to the following composition for forming an optical compensation layer 17-2, and the coating film thickness was adjusted such that Rth was −90 nm.

Composition for forming optical compensation layer 17-2

| | |
|---|---|
| Rod-like liquid crystal compound-1 shown above | 83 parts by mass |
| Rod-like liquid crystal compound-2 shown above | 15 parts by mass |
| Rod-like liquid crystal compound-3 shown above | 2 parts by mass |
| Polymerizable monomer (M-1) shown above | 8 parts by mass |
| Polymerization initiator (Irgacure 127, | 2 parts by mass |
| manufactured by BASF SE) | |
| Polymerization initiator (Irgacure OXE01, | 4 parts by mass |
| manufactured by BASF SE) | |
| Surfactant F-1 shown above | 0.62 parts by mass |
| Surfactant F-2 shown above | 0.82 parts by mass |
| Onium compound S01 shown above | 2 parts by mass |
| Polymer compound A-1 shown above | 5 parts by mass |
| Toluene | 621 parts by mass |
| Methyl ethyl ketone | 69 parts by mass |

### [Production of Optical Compensation Layer 17]

The optical compensation layer 17-1 and the optical compensation layer 17-2, produced by the above-described procedures, were prepared, and the optical compensation layers were bonded to each other using a commercially available pressure-sensitive adhesive (manufactured by Soken Chemical & Engineering Co., Ltd., SK2057) such that the coating layers faced each other, thereby producing an optical compensation layer 17. Regarding the produced optical compensation layer 17, Re was 125 nm, Rth was −150 nm, and the Nz factor was −0.7.

### [Production of Image Display Device A17]

An image display device A17 was produced in the same manner as in Example 16, except that, in the production of the image display device A16 of Example 16, the optical compensation layer 16 was changed to the above-described optical compensation layer 17, the optical compensation layer 17-1 included in the optical compensation layer 17 was disposed to be on the light-absorbing anisotropic layer 1 side, and the polarizing plate was bonded such that the absorption axis of the polarizing plate and the slow axis of the optical compensation layer 17 were orthogonal to each other.

In the produced image display device A17, it was confirmed that the alignment direction of the liquid crystal compound changed by turning on and off the voltage (20 V) applied to the VA liquid crystal cell 13, and the light shielding mode (ON) and the transmission mode (OFF) could be switched.

### Example 18

### [Production of ECB Liquid Crystal Cell 14]

A polyimide film was provided as an alignment film on a glass substrate with an ITO electrode, and the alignment film was subjected to a rubbing treatment. The obtained two glass substrates were bonded to each other in a disposition in which the rubbing directions were parallel to each other. A liquid crystal material (MLC-9100 manufactured by Merck KGaA) having positive dielectric constant anisotropy was dropped and injected between the upper and lower substrates, and sealed to produce a liquid crystal cell. In this case, a cell gap between the substrates was adjusted such that Δnd at a wavelength of 550 nm was adjusted to 275 nm. An ECB liquid crystal cell 14, which was a liquid crystal cell of the ECB type, was obtained by the above-described procedure.

### [Production of Image Display Device A18]

An image display device A18 was produced in the same manner as in Example 17, except that, in the production of the image display device A17 of Example 17, the liquid crystal cell 13 was changed to the liquid crystal cell 14.

In the produced image display device A18, it was confirmed that the alignment direction of the liquid crystal compound changed by turning on and off the voltage (10 V) applied to the ECB liquid crystal cell, and the light shielding mode (OFF) and the transmission mode (ON) could be switched.

### Comparative Example 3

### [Production of Image Display Device B3]

An image display device B3 was produced in the same manner as in the image display device A15, except that the optical compensation layer 15 was not bonded in the production of the image display device A15 of Example 15.

### Comparative Example 4

### [Production of Image Display Device B4]

An image display device B4 was produced in the same manner as in the image display device A18, except that the optical compensation layer 17 was not bonded in the production of the image display device A18 of Example 18.

### Example 19

### [Production of Optical Compensation Layer 19]

In the production of the optical compensation layer 1 of Example 1, by adjusting the film thickness, the stretching temperature, and the stretching ratio, a stretching film in which Re was 150 nm, Rth was 300 nm, and the Nz factor was 2.5 was obtained. The stretching film was used as an optical compensation layer 19.

### [Production of Alignment Film for Multi-Domain]

A commercially available polyimide alignment film (SE-150 manufactured by Nissan Chemical Corporation) was coated on a glass substrate with an electrode, and the film was heated at 250° C. for 1 hour. The alignment film was divided into two regions by a mask rubbing treatment to produce an alignment film for a multi-domain, in which the rubbing axis was a direction of 90° in a region 1 and a direction of 270° in a region 2.

### [Production of Substrate for Multi-Domain]

100 parts by mass of the following disk-like liquid crystal compound 1, 0.8 parts by mass of the following polymer compound 2, part by mass of a photopolymerization initiator (IRGACURE 907, manufactured by Ciba-Geigy), and part by mass of a sensitizer (KAYACURE DETX, manufactured by Nippon Kayaku Co., Ltd.) were dissolved in 200 parts by mass of methyl ethyl ketone to prepare a coating liquid. The coating liquid was spin-coated on a surface of the above-described alignment film for a multi-domain. The coating film was heated at 120° C. for 2 minutes in a constant temperature zone to align the disk-like liquid crystal compound. Next, the disk-like liquid crystal compound was polymerized by irradiating with UV rays for 1 minute using a high-pressure mercury lamp under a condition of 120 W/cm² in an atmosphere of 70° C. to fix the alignment state. Thereafter, the substrate was allowed to cool to room temperature. In this way, a substrate for a multi-domain was produced. As a result of observing the substrate for a multi-domain with a polarizing microscope, it was confirmed that the disk-like liquid crystal compound was aligned in the rubbing direction in each domain.

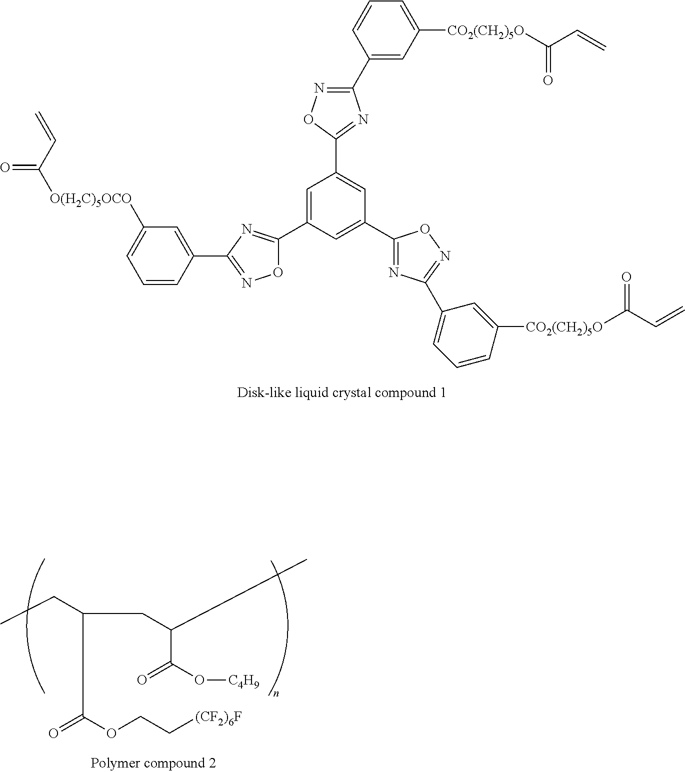

### [Production of VA Liquid Crystal Cell 15]

A VA liquid crystal cell 15 was produced in the same manner as in Example 15, except that, in the production of the VA liquid crystal cell 13 of Example 15, the substrate was used as the substrate for a multi-domain produced as described above, and Δnd of the liquid crystal layer was set to 700 nm by adjusting the interval (gap; d) of the substrates.

### [Production of Image Display Device A19]

An image display device A19 was produced in the same manner as in Example 15, except that, in the production of the image display device A15 of Example 15, the liquid crystal cell 13 was changed to the liquid crystal cell 15, the optical compensation layer 15 was changed to the above-described optical compensation layer 19, and the polarizing plate was bonded such that the absorption axis of the polarizing plate and the slow axis of the optical compensation layer 19 were parallel to each other. In this case, the bonding was performed such that the alignment direction of the liquid crystal in a state of applying a voltage (20 V) to the VA liquid crystal cell 15 and the absorption axis of the polarizing plate were parallel to each other. In the produced image display device A19, it was confirmed that the alignment direction of the liquid crystal compound changed by turning on and off the voltage (2.4 V) applied to the VA liquid crystal cell 15, and the light shielding mode (OFF) and the transmission mode (ON) could be switched.

### Example 20

### [Production of Optical Compensation Layer 20-1]

An optical compensation layer 20-1 was produced in the same manner as in Example 17, except that, in the production of the optical compensation layer 17-1 of Example 17, the coating film thickness was adjusted such that Re was 150 nm and Rth was −75 nm.

### [Production of Optical Compensation Layer 20]

The optical compensation layer 20-1 and the optical compensation layer 8, produced by the above-described procedures, were prepared, and the optical compensation layers were bonded to each other using a commercially available pressure-sensitive adhesive (manufactured by Soken Chemical & Engineering Co., Ltd., SK2057) such that the coating layers faced each other, thereby producing an optical compensation layer 20. Regarding the produced optical compensation layer 20, Re was 150 nm, Rth was −375 nm, and the Nz factor was −2.0.

### [Production of Image Display Device A20]

An image display device A20 was produced in the same manner as in Example 19, except that, in the production of the image display device A19 of Example 19, the optical compensation layer 19 was changed to the above-described optical compensation layer 20, the optical compensation layer 20-1 layer included in the optical compensation layer 20 was disposed to be on the liquid crystal cell 15 side, and the polarizing plate was bonded such that the absorption axis of the polarizing plate and the slow axis of the optical compensation layer 17 were orthogonal to each other.

In the produced image display device A20, it was confirmed that the alignment direction of the liquid crystal compound changed by turning on and off the voltage (2.4 V) applied to the VA liquid crystal cell 15, and the light shielding mode (OFF) and the transmission mode (ON) could be switched.

### Example 21

### [Production of Optical Compensation Layer 21]

In the production of the optical compensation layer 1 of Example 1, by adjusting the film thickness, the stretching temperature, and the stretching ratio, a stretching film in which Re was 75 nm, Rth was 125 nm, and the Nz factor was 2.2 was obtained. The stretching film was used as an optical compensation layer 21.

### [Production of Image Display Device A21]

An image display device A21 was produced in the same manner as in Example 16, except that, in the production of the image display device A16 of Example 16, the optical compensation layer 16 was changed to the above-described optical compensation layer 21, the liquid crystal cell 13 was changed to the liquid crystal cell 15, and the polarizing plate was bonded such that the absorption axis of the polarizing plate and the slow axis of the optical compensation layer 17 were orthogonal to each other.

In the produced image display device A21, it was confirmed that the alignment direction of the liquid crystal compound changed by turning on and off the voltage (2.4 V) applied to the VA liquid crystal cell 15, and the light shielding mode (OFF) and the transmission mode (ON) could be switched.

### Comparative Example 5

### [Production of Image Display Device B5]

An image display device B5 was produced in the same manner as in the image display device A19, except that the optical compensation layer 19 was not bonded in the production of the image display device A19 of Example 19.

### <Evaluation of Viewing Angle Control System>

### [Evaluation of Visibility in Left-Right Direction]

Light shielding properties and transmittance properties of the image display devices of Examples 1 to 21 and Comparative Examples 1 to 5 were evaluated by the following procedure.

That is, in each of the above-described image display devices, in a case where the up-down direction of the image display region of the above-described notebook computer was set to an azimuthal angle of 0°, visibility of the display image in the light shielding mode and the transmission mode in a case of being viewed from an azimuthal angle of 90° (right direction) and a polar angle of 45° was evaluated. The visibility (light shielding properties) in the light shielding mode and the visibility (transmittance properties) in the transmission mode were evaluated based on the following standards. The results are shown in the tables below.

In a case where the same evaluation was performed in a case of being viewed from an azimuthal angle of 270° (left direction) and a polar angle of 45°, the same evaluation result as in the right direction was obtained.

### (Visibility in Light Shielding Mode)

A: image could not be recognized.
B: image was difficult to be recognized.
C: image could be slightly recognized.
D: image could be recognized.

In practice, the evaluation of A to C is preferable.

### (Visibility in Transmission Mode)

A: image could be recognized, and appeared bright.
B: image could be recognized, but appeared slightly dark.
C: image was dark, and difficult to be recognized.

In practice, the evaluation of A or B is preferable.

### [Evaluation of Visibility in Other Directions]

For the image display devices of Examples 5 to 14 and Comparative Example 2, visibility of the display image in a case of being observed from the up-down direction (azimuthal angles of 0° and 180°), the oblique upper right direction (azimuthal angle of 45°), the oblique lower right direction (azimuthal angle of 135°), the oblique lower left direction (azimuthal angle of 225°), and the oblique upper left direction (azimuthal angle of 315°), in addition to the left-right direction, was evaluated.

Specifically, in the above-described evaluation, in a case where the left-right direction was in the transmission mode, the visibility (visibility in other directions) of the display image in a case of being observed from the above-described azimuthal angles and a polar angle of 45° was evaluated according to the following standard. The results are shown in the tables below.

(Visibility from Other Directions in Transmission Mode)
A+: image could be recognized brightly from any of the above-described directions.
A: image could be recognized from any of the above-described directions, but it appeared slightly dark in some directions.
B: image could be recognized from any of the above-described directions, but the image was generally dark.
C: in the above-described directions, there was a direction in which the image was dark and difficult to be recognized.

### Result

The configurations of the image display devices of Examples and Comparative Examples and the above-described evaluation results are shown in Tables 1 to 4.

The column of “Switching angle” of the liquid crystal cell indicates what angle of the in-plane slow axis of the liquid crystal cell with respect to the absorption axis direction of the polarizer in the polarizing plate could be set to.

TABLE 1

| | | | | | | Comparative |
|---|---|---|---|---|---|---|
| | | Example 1 | Example 2 | Example 3 | Example 4 | Example 1 |
| | | image display | image display | image display | image display | image display |
| | | device A1 | device A2 | device A3 | device A4 | device B1 |
| Configuration | | Light-absorbing | Light-absorbing | Light-absorbing | Light-absorbing | Light-absorbing |
| | | anisotropic | anisotropic | anisotropic | anisotropic | anisotropic |
| | | layer 1 | layer 1 | layer 1 | layer 1 | layer 1 |
| | | Liquid crystal | Liquid crystal | Optical | Optical | Liquid crystal |
| | | cell 1 | cell 1 | compensation | compensation | cell 1 |
| | | Optical | Optical | layer 3 | layer 4 | Polarizing plate |
| | | compensation | compensation | Liquid crystal | Liquid crystal | Liquid crystal |
| | | layer 1 | layer 2 | cell 1 | cell 1 | display device |
| | | Polarizing plate | Polarizing plate | Polarizing plate | Polarizing plate | |
| | | Liquid crystal | Liquid crystal | Liquid crystal | Liquid crystal | |
| | | display device | display device | display device | display device | |
| Optical | Re | 150 | 200 | 65 | 120 | — |
| compensation | Rth | 150 | 100 | 420 | 420 | — |
| layer | Nz factor | 1.5 | 1.0 | 7.0 | 4.0 | — |
| Liquid | Re | 275 | 275 | 275 | 275 | 275 |
| crystal | Switching | 0° ↔ 45° | 0° ↔ 45° | 0° ↔ 45° | 0° ↔ 45° | 0° ↔ 45° |
| cell | angle | | | | | |
| Evaluation | Light shielding | C | B | B | A | D |
| | properties | | | | | |
| | Transmittance | A | A | A | A | A |
| | properties | | | | | |

TABLE 2(1)

| | | Example 5 | Example 6 | Example 7 | Example 8 | Example 9 | Example 10 |
|---|---|---|---|---|---|---|---|
| | | image display | image display | image display | image display | image display | image display |
| | | device A5 | device A6 | device A7 | device A8 | device A9 | device A10 |
| Configuration | | Light- | Light- | Light- | Light- | Light- | Light- |
| | | absorbing | absorbing | absorbing | absorbing | absorbing | absorbing |
| | | anisotropic | anisotropic | anisotropic | anisotropic | anisotropic | anisotropic |
| | | layer 1 | layer 1 | layer 1 | layer 1 | layer 1 | layer 1 |
| | | Liquid crystal | Liquid crystal | Liquid crystal | Liquid crystal | Optical | Optical |
| | | cell 5 | cell 5 | cell 7 | cell 7 | compensation | compensation |
| | | Optical | Optical | Optical | Optical | layer 9 | layer 10 |
| | | compensation | compensation | compensation | compensation | Liquid crystal | Liquid crystal |
| | | layer 5 | layer 6 | layer 7 | layer 8 | cell 9 | cell 9 |
| | | Polarizing | Polarizing | Polarizing | Polarizing | Polarizing | Polarizing |
| | | plate | plate | plate | plate | plate | plate |
| | | Liquid crystal | Liquid crystal | Liquid crystal | Liquid crystal | Liquid crystal | Liquid crystal |
| | | display device | display device | display device | display device | display device | display device |
| Optical | Re | 50 | 3 | 75 | 4 | 75 | 120 |
| compensation | Rth | 100 | 200 | 150 | −300 | 500 | 420 |
| layer | Nz factor | 2.5 | 67.2 | 2.5 | −74.5 | 7.2 | 4.0 |
| Liquid | Re | 140 | 140 | 400 | 400 | 275 | 275 |
| crystal | Switching | 0° ↔ 45° | 0° ↔ 45° | 0° ↔ 45° | 0° ↔ 45° | 0° ↔ 60° | 0° ↔ 60° |
| cell | angle | | | | | | |
| Evaluation | Light | B | A | B | A | B | A |
| | shielding | | | | | | |
| | properties | | | | | | |
| | Transmittance | B | B | B | B | A | A |
| | properties | | | | | | |
| | Visibility in | C | C | C | B | B | A |
| | other | | | | | | |
| | directions | | | | | | |

TABLE 2(2)

| | | | | | | Comparative |
|---|---|---|---|---|---|---|
| | | Example 11 | Example 12 | Example 13 | Example 14 | Example 2 |
| | | image display | image display | image display | image display | image display |
| | | device A11 | device A12 | device A13 | device A14 | device B2 |
| Configuration | | Light-absorbing | Light-absorbing | Light-absorbing | Light-absorbing | Light-absorbing |
| | | anisotropic | anisotropic | anisotropic | anisotropic | anisotropic |
| | | layer 1 | layer 1 | layer 1 | layer 1 | layer 1 |
| | | Optical | Optical | Optical | Optical | Liquid crystal |
| | | compensation | compensation | compensation | compensation | cell 5 |
| | | layer 11 | layer 12 | layer 13 | layer 14 | Polarizing plate |
| | | Liquid crystal | Liquid crystal | Liquid crystal | Liquid crystal | Liquid crystal |
| | | cell 11 | cell 12 | cell 12 | cell 12 | display device |
| | | Polarizing plate | Polarizing plate | Polarizing plate | Polarizing plate | |
| | | Liquid crystal | Liquid crystal | Liquid crystal | Liquid crystal | |
| | | display device | display device | display device | display device | |
| Optical | Re | 200 | 150 | 150 | 200 | — |
| compensation | Rth | 180 | 500 | 300 | 300 | — |
| layer | Nz factor | 1.4 | 3.8 | 2.5 | 2.0 | — |
| Liquid | Re | 275 | 350 | 350 | 350 | 140 |
| crystal | Switching | 90° ↔ 65° | 0° ↔ 65° | 0° ↔ 65° | 0° ↔ 65° | 0° ↔ 45° |
| cell | angle | | | | | |
| Evaluation | Light shielding | A | A | B | A | D |
| | properties | | | | | |
| | Transmittance | A | B | A | A | B |
| | properties | | | | | |
| | Visibility in | A+ | C | B | A+ | B |
| | other directions | | | | | |

TABLE 3

| | | | | | | Comparative | Comparative |
|---|---|---|---|---|---|---|---|
| | | Example 15 | Example 16 | Example 17 | Example 18 | Example 3 | Example 4 |
| | | image display | image display | image display | image display | image display | image display |
| | | device A15 | device A16 | device A17 | device A18 | device B3 | device B4 |
| Configuration | | Light- | Light- | Light- | Light- | Light- | Light- |
| | | absorbing | absorbing | absorbing | absorbing | absorbing | absorbing |
| | | anisotropic | anisotropic | anisotropic | anisotropic | anisotropic | anisotropic |
| | | layer 1 | layer 1 | layer 1 | layer 1 | layer 1 | layer 1 |
| | | Liquid crystal | Optical | Optical | Optical | Liquid crystal | Liquid crystal |
| | | cell 13 | compensation | compensation | compensation | cell 13 | cell 14 |
| | | Optical | layer 16 | layer 17 | layer 17 | Polarizing | Polarizing |
| | | compensation | Liquid crystal | Liquid crystal | Liquid crystal | plate | plate |
| | | layer 15 | cell 13 | cell 13 | cell 14 | Liquid crystal | Liquid crystal |
| | | Polarizing | Polarizing | Polarizing | Polarizing | display device | display device |
| | | plate | plate | plate | plate | | |
| | | Liquid crystal | Liquid crystal | Liquid crystal | Liquid crystal | | |
| | | display device | display device | display device | display device | | |
| Optical | Re | 200 | 200 | 125 | 125 | — | — |
| compensation | Rth | 400 | 600 | −150 | −150 | — | — |
| layer | Nz factor | 2.5 | 3.5 | −0.7 | −0.7 | — | — |
| Liquid | Δnd | 275 | 275 | 275 | 275 | 275 | 275 |
| crystal | Alignment | 45° | 45° | 45° | 45° | 45° | 45° |
| cell | angle | | | | | | |
| | Switching | 0 V ↔ 20 V | 0 V ↔ 20 V | 0 V ↔ 20 V | 10 V ↔ 0 V | 0 V ↔ 20 V | 10 V ↔ 0 V |
| | voltage | | | | | | |
| Evaluation | Light | B | C | A | A | D | D |
| | shielding | | | | | | |
| | properties | | | | | | |
| | Transmittan | A | A | A | A | A | A |
| | ce | | | | | | |
| | properties | | | | | | |

TABLE 4

| | | | | | Comparative |
|---|---|---|---|---|---|
| | | Example 19 | Example 20 | Example 21 | Example 5 |
| | | image display | image display | image display | image display |
| | | device A19 | device A20 | device A21 | device B5 |
| Configuration | | Light-absorbing | Light-absorbing | Light-absorbing | Light-absorbing |
| | | anisotropic | anisotropic | anisotropic | anisotropic |
| | | layer 1 | layer 1 | layer 1 | layer 1 |
| | | Liquid crystal | Liquid crystal | Optical | Liquid crystal |
| | | cell 15 | cell 15 | compensation | cell 15 |
| | | Optical | Optical | layer 21 | Polarizing plate |
| | | compensation | compensation | Liquid crystal | Liquid crystal |
| | | layer 19 | layer 20 | cell 15 | display device |
| | | Polarizing plate | Polarizing plate | Polarizing plate | |
| | | Liquid crystal | Liquid crystal | Liquid crystal | |
| | | display device | display device | display device | |
| Optical | Re | 150 | 150 | 75 | — |
| compensation | Rth | 300 | −375 | 125 | — |
| layer | Nz factor | 2.5 | −2.0 | 2.2 | — |
| Liquid | Δnd | 700 | 700 | 700 | 700 |
| crystal | Alignment angle | 90° | 90° | 90° | 90° |
| cell | Switching voltage | 0 V ↔ 2.4 V | 0 V ↔ 2.4 V | 0 V ↔ 2.4 V | 0 V ↔ 2.4 V |
| Evaluation | Light shielding | A | A | B | D |
| | properties | | | | |
| | Transmittance | B | B | A | B |
| | properties | | | | |
| | Visibility in other | A | A | A+ | A |
| | directions | | | | |

From the results shown in Tables 1 to 4, in the image display devices of Comparative Examples, including no optical compensation layer, the light shielding properties were inferior to those of the image display devices of Examples, including the optical compensation layer.

### EXPLANATION OF REFERENCES

10a, 10b: viewing angle control system
12: light-absorbing anisotropic layer
14: liquid crystal cell
16: polarizer
18: optical compensation layer
20: display panel
100a, 100b: image display device

What is claimed is:

1. A viewing angle control system comprising, in the following order:
a light-absorbing anisotropic layer;
a liquid crystal cell; and
a polarizer,
wherein an angle formed by a transmittance central axis of the light-absorbing anisotropic layer and a normal line of the light-absorbing anisotropic layer is 0° to 45°,
an optical compensation layer is provided in at least one of a space between the light-absorbing anisotropic layer and the liquid crystal cell or a space between the liquid crystal cell and the polarizer, and
the viewing angle control system does not include another light-absorbing anisotropic layer and another polarizer between the light-absorbing anisotropic layer and the polarizer.

2. The viewing angle control system according to claim 1,
wherein the liquid crystal cell is an in-plane-switching type liquid crystal cell.

3. The viewing angle control system according to claim 2,
wherein a Re of the liquid crystal cell is 250 to 300 nm,
an angle formed by an absorption axis of the polarizer and an in-plane slow axis of the liquid crystal cell can be controlled to a state of 85° to 95° and a state of 40° to 50°, and
the optical compensation layer satisfies relationships (1A) and (1B),
$$125 nm \leq Re \leq 250 nm \qquad relationship ( 1 A )$$
$$- 0.2 \leq Nz \leq 1.6 \qquad relationship ( 1 B )$$
in relationship (1B), Nz represents a value of a Nz factor of the optical compensation layer.

4. The viewing angle control system according to claim 2,
wherein a Re of the liquid crystal cell is 250 to 300 nm,
an angle formed by an absorption axis of the polarizer and an in-plane slow axis of the liquid crystal cell can be controlled to a state of 85° to 95° and a state of 40° to 50°, and
the optical compensation layer satisfies relationships (2A) and (2B),
$$50 nm \leq Re \leq 200 nm \qquad relationship ( 2 A )$$
$$2. \leq Nz \leq 8. \qquad relationship ( 2 B )$$
in relationship (2B), Nz represents a value of a Nz factor of the optical compensation layer.

5. The viewing angle control system according to claim 1,
wherein the liquid crystal cell is a vertical alignment type liquid crystal cell or an electrically controlled birefringence type liquid crystal cell.

6. The viewing angle control system according to claim 5,
wherein Δnd of the liquid crystal cell is 210 to 300 nm,
an angle formed by an absorption axis of the polarizer and an in-plane slow axis of the liquid crystal cell can be controlled to a state of 35° to 55° and a state in which an alignment direction of a liquid crystal compound of the liquid crystal cell is parallel to a thickness direction of the liquid crystal cell, and
the optical compensation layer satisfies relationships (7A) and (7B),
$$125 nm \leq Re \leq 250 nm \qquad relationship ( 7 A )$$
$$1.5 \leq Nz \leq 6.5 \qquad relationship ( 7 B )$$
in relationship (7B), Nz represents a value of a Nz factor of the optical compensation layer.

7. The viewing angle control system according to claim 5,
wherein Δnd of the liquid crystal cell is 210 to 300 nm,
an angle formed by an absorption axis of the polarizer and an in-plane slow axis of the liquid crystal cell can be controlled to a state of 35° to 55° and a state in which an alignment direction of a liquid crystal compound of the liquid crystal cell is parallel to a thickness direction of the liquid crystal cell, and
the optical compensation layer satisfies relationships (8A) and (8B),
$$50 nm \leq Re \leq 200 nm \qquad relationship ( 8 A )$$
$$- 7.5 \leq Nz \leq 1. \qquad relationship ( 8 B )$$
in relationship (8B), Nz represents a value of a Nz factor of the optical compensation layer.

8. The viewing angle control system according to claim 1,
wherein the optical compensation layer is disposed between the light-absorbing anisotropic layer and the liquid crystal cell.

9. The viewing angle control system according to claim 2,
wherein the optical compensation layer is disposed between the light-absorbing anisotropic layer and the liquid crystal cell.

10. The viewing angle control system according to claim 3,
wherein the optical compensation layer is disposed between the light-absorbing anisotropic layer and the liquid crystal cell.

11. The viewing angle control system according to claim 4,
wherein the optical compensation layer is disposed between the light-absorbing anisotropic layer and the liquid crystal cell.

12. The viewing angle control system according to claim 5,
wherein the optical compensation layer is disposed between the light-absorbing anisotropic layer and the liquid crystal cell.

13. An image display device comprising:
the viewing angle control system according to claim 1.

14. An image display device comprising:
the viewing angle control system according to claim 2.

15. An image display device comprising:
the viewing angle control system according to claim 3.

16. An image display device comprising:
the viewing angle control system according to claim 4.

17. An image display device comprising:
the viewing angle control system according to claim 5.

18. An image display device comprising:
the viewing angle control system according to claim 6.

19. An image display device comprising:
the viewing angle control system according to claim 7.

20. An image display device comprising:
the viewing angle control system according to claim 8.
